(19) United States
(12) Patent Application Publication
(10) Pub. No.: US 2007/0070859 A1
(43) Pub. Date: Mar. 29, 2007

(54) Optical elements and combiner optical systems and image-display units comprising same

(75) Inventor: Yoshikazu Hirayama, Chiba-shi (JP)

Correspondence Address: KLARQUIST SPARKMAN, LLP, 121 SW SALMON STREET, SUITE 1600, PORTLAND, OR, 97204, US

(73) Assignee: Nikon Corporation

(21) Appl. No.: 11/600,664

(22) Filed: Nov. 15, 2006

Related U.S. Application Data
(63) Continuation of application No. PCT/JP05/07038, filed on Nov. 4, 2005.

(30) Foreign Application Priority Data
May 17, 2004 (JP) 2004-146579
Dec. 3, 2004 (JP) 2004-351327

(51) Int. Cl. G11B 7/135

(52) U.S. Cl. 369/112.04

(57) ABSTRACT

Light-propagating optical elements are disclosed that have an internal-reflection and a see-through feature not damaged even if a member higher in refractive index than the surrounding medium is brought into in close contact with the surface thereof. An optical element includes a substrate having an interior in which a specified light flux propagates, and an optical-function unit in close contact with the surface of the substrate. Thus, the propagating specified light flux can reach the optical element. The optical-function unit has interfering or diffracting actions that reflects the specified light flux and transmits an external light flux reaching the surface. The optical element, when used, can be or constitute a combiner optical system that can provide functions such as diopter correction. An image-display unit that can be easily mounted can function to provide the diopter correction.

### CROSS REFERENCE TO RELATED APPLICATION

This application is a continuation of, and claims the benefit of PCT application no. PCT/JP 2005/007038, designating the United States and incorporated herein by reference in its entirety.

### FIELD

This disclosure relates to light-propagating optical elements having a see-through feature. The disclosure also pertains to combiner optical systems using such an optical element, and image-display units that use such a combiner optical system.

### BACKGROUND

A high-refractive index material (transparent substrate) such as a glass substrate existing in a low-refractive-index medium such as air, vacuum, or other gas causes internal reflection of a light flux that is incident thereon. The reflection is at an angle that is larger than a critical angle unique to the transparent substrate; a light flux that is incident thereon at an angle smaller than the critical angle is transmitted. That is, the material has an internal-reflection function and a see-through feature. Image-display units utilizing such a transparent substrate as a light-propagating optical element are eyeglass displays as discussed in Japan Patent Publication No. 2003-264682 and in PCT Internal Japanese Publication No. 2003-536102. In these eyeglass displays, a transparent substrate is disposed in front of the eye of a viewer. An image-carrying light flux from an image-display element propagates in the transparent substrate to a position immediately short of the pupil of the viewing eye. The light flux is further superimposed on an external light flux on a combiner such as a half-mirror provided in the transparent substrate. The light flux is then incident on the pupil. Such an eyeglass display enables the viewer to view images of an external field and the image-display element at the same time.

To realize widespread use of eyeglass displays, there is a need to add the same function(s) (e.g., diopter correction) as provided by regular eyeglasses, in addition to other various functions of the displays.

In an eyeglass display utilizing the internal reflection of a transparent substrate, it is conventionally impossible for the transparent substrate itself to have a curved surface to have any refractive power. It is also impossible to adhere another refractive member having a refractive power (e.g., a plano-convex lens or a plano-concave lens having a refractive index equal to or higher than that of the transparent substrate) on a surface of the transparent substrate.

A conventional approach to this problem of including diopter correction is to attach such a refractive member on the surface of the transparent substrate via an air gap. But, this involves various difficulties. For example, it is difficult to obtain sufficient mechanical strength while maintaining an air gap having the required accuracy. The approach also is accompanied by an increase in the number of parts, weight, thickness, and the like, which complicates manufacturing and increases cost. Further, depending on the positional relationship between the viewing eye and the transparent substrate, excessive light reflected by the air gap is sometimes incident on the viewing eye, which impairs visibility.

### SUMMARY

This invention addresses the foregoing problems and has as an object to provide light-propagating optical elements. Various embodiments include an internal-reflection function and a see-through feature that are not damaged even if a member such as a refractive member having a greater refractive index than the surrounding medium is brought into close contact with a surface of the optical element. Another object is to provide a combiner optical systems that can be easily provided with a function such as diopter correction, and to provide image-display units that can be easily provided with a function such as diopter correction.

An embodiment of an optical element comprises a plane substrate having an interior. A specified light flux is able to propagate in the interior. An optical-function unit is provided in close contact with a surface of the plane substrate. The optical-function unit is reachable by the propagating specified light flux and is configured to reflect the specified light flux and to transmit, interfere with, or diffract an external light flux reaching the surface. The optical-function unit can be configured to reflect a specified light flux that is polarized in a specific direction and to transmit a light flux that is polarized in another direction.

The optical-function unit can be configured to reflect, with a desired reflection characteristic, the specified light flux reaching the surface at an incidence angle that is equal to or greater than a critical angle. The critical angle is determined by the refractive indexes of the plane substrate and air, and is a condition under which a light flux in the interior of the plane substrate is totally reflected. The optical-function unit also or alternatively can be configured to reduce the external light flux without increasing attenuation of intensity of a light path of the specified light flux.

According to another aspect, combiner optical systems are provided. An embodiment comprises an optical element, summarized above, in which an image-carrying light flux radiated from a specified image-display element propagates, and that transmits the external light flux directed from an external field to a viewing eye at least in a state in which the plane substrate faces the viewing eye. The combiner can be provided in the optical element and configured to reflect the image-carrying light flux, that has propagated in the plane substrate, toward the viewing eye and to transmit the external light flux.

The optical-function unit may be an optical film provided on the surface of the plane substrate. A second plane substrate may be provided on a surface of the optical film. The second plane substrate may be a refractor that provides diopter correction. The optical-function unit can be provided on an external-side surface of the plane substrate. An optical system including the optical-function unit and the second plane substrate can be configured to attenuate the external light flux without increasing attenuation of light intensity of an optical path of the image-carrying light flux. The second plane substrate can be configured to absorb visible light.

The optical film can be configured to attenuate the external light flux without increasing attenuation of light intensity of an optical path of the image-carrying light flux. The optical film can be made of metal and/or a dielectric or can be made of a holographic optical film. The second optical film can be provided on a surface of the second plane substrate. The second optical film can be made of metal and/or a dielectric, can be made of a holographic optical film, can be made of an electrochromic film, or can be made of a photochromic film.

The optical system including the optical-function unit and the second plane substrate can be configured to attenuate the external light flux that is incident on the combiner, at a higher reduction ratio than the reduction ratio at which a rest of the external light flux is attenuated.

The combiner optical system of the present invention can further comprise a guide mirror configured to guide the image-carrying light flux, radiated from the image-display element, in a direction allowing the image-carrying light flux to be internally reflected in the plane substrate.

According to another aspect, an image-display unit is provided. An embodiment includes an image-display element that radiates an image-carrying light flux for image display. The embodiment also includes the combiner optical system configured to guide the image-carrying light flux to the viewing eye. The image-display unit can further include a mounting member with which the combiner optical system is worn on the head of a viewer.

According to the invention, light-propagating optical elements are realized that have an internal-reflection function and a see-through feature that cannot be damaged even if a member higher in refractive index than the surrounding medium is brought into close contact with its surface.

According to the invention, combiner optical systems are provided that can be easily configured to provide diopter correction. Also provided are image-display units that can be easily configured to provide diopter correction.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is an external view of an eyeglass display of a first representative embodiment.

FIG. 2 is a schematic sectional view of an optical-system portion of the eyeglass display of the first representative embodiment taken along a horizontal plane of a viewer.

FIG. 3 is a chart showing angle characteristics of reflectance of a glass substrate in the air.

FIG. 4 is a view showing an optical system for manufacturing a HOE.

FIG. 5 is a chart showing angle characteristics of reflectance of a first example.

FIG. 6 is a chart showing a wavelength characteristic of reflectance for vertically incident light of the first example.

FIG. 7 is a chart showing wavelength characteristics of reflectance for 60° incident light of the first example.

FIG. 8 is a chart showing angle characteristics of reflectance of a second example.

FIG. 9 is a chart showing a wavelength characteristic of reflectance for vertically incident light of the second example.

FIG. 10 is a chart showing wavelength characteristics of reflectance for 60° incident light of the second example.

FIG. 11 is a chart showing angle characteristics of reflectance of a third example.

FIG. 12 is a chart showing a wavelength characteristic of reflectance for vertically incident light of the third example.

FIG. 13 is a chart showing wavelength characteristics of reflectance for 60° incident light of the third example.

FIG. 14 is a chart showing a film structure of a fourth example.

FIG. 15 is a chart showing angle characteristics of reflectance of the fourth example.

FIG. 16 is a chart showing a wavelength characteristic of reflectance for vertically incident light of the fourth example.

FIG. 17 is a chart showing wavelength characteristics of reflectance for 60° incident light of the fourth example.

FIG. 18 is a chart showing a film structure of a fifth example.

FIG. 19 is a chart showing angle characteristics of reflectance of the fifth example.

FIG. 20 is a chart showing a wavelength characteristic of reflectance for vertically incident light of the fifth example.

FIG. 21 is a chart showing wavelength characteristics of reflectance for 60° incident light of the fifth example.

FIG. 22 is a schematic sectional view of an optical-system portion of an eyeglass display of a second representative embodiment taken along a horizontal plane of a viewer.

FIG. 23 is a view showing an optical system for manufacturing a HOE applied to a reinforcing reflective film of the second representative embodiment.

FIG. 24 is a chart showing a film structure of a sixth example.

FIG. 25 shows wavelength characteristics of reflectance for light at small incidence angles (0° to 20°) of the sixth example.

FIG. 26 shows wavelength characteristics of reflectance for lights at large incidence angles (35° and 40°) of the sixth example.

FIG. 27 shows angle characteristics of reflectance for light having respective wavelengths of a dielectric optical multilayer film of the sixth example.

FIG. 28 is a schematic sectional view of an optical-system portion of an eyeglass display of a third representative embodiment taken along a horizontal plane of a viewer.

FIG. 29 is a chart showing a film structure of a seventh example.

FIG. 30 shows wavelength characteristics of reflectance for light at small incidence angles (0° to 20°) of the seventh example.

FIG. 31 shows wavelength characteristics of reflectance for light at large incidence angles (35° to 50°) of the seventh example.

FIG. 32 shows angle characteristics of reflectance for light having respective wavelengths of a dielectric optical multilayer film of the seventh example.

FIG. 33 is a schematic sectional view of an optical-system portion of an eyeglass display of a fourth representative embodiment taken along a horizontal plane of a viewer.

FIG. 34 is a schematic sectional view of an optical-system portion of an eyeglass display of a fifth representative embodiment taken along a horizontal plane of a viewer.

FIG. 35 is an exploded view of an optical-system portion of an eyeglass display of a sixth representative embodiment.

FIG. 36 are views for explaining an eyeglass display of a seventh representative embodiment.

FIG. 37 is an external view of the eyeglass display of an eighth representative embodiment.

FIG. 38 is a detailed view of the optical system of the eyeglass display of the eighth representative embodiment.

FIG. 39 shows a wavelength characteristic of refractive index of an Ag layer.

FIG. 40 shows a wavelength characteristic of the extinction coefficient of the Ag layer.

FIG. 41 shows wavelength characteristics of reflectance and transmittance of the plane-substrate side of the light-reducing film of the eighth representative embodiment.

FIG. 42 shows angle characteristics of reflectance and transmittance of the plane-substrate side of the light-reducing film of the eighth representative embodiment.

FIG. 43 is a chart showing the film structure of the light-reducing film of a first modification example of the eighth representative embodiment.

FIG. 44 shows a wavelength characteristic of transmittance of the light-reducing film of the first modification example of the eighth representative embodiment.

FIG. 45 is a chart showing the film structure of the light-reducing film of a second modification example of the eighth representative embodiment.

FIG. 46 shows a wavelength characteristic of transmittance of the light-reducing film of the second modification example of the eighth representative embodiment.

FIGS. 47(A) and 47(B) are views for explaining reflection on an air-side interface of a plane substrate and reflection on a light-reducing-film side interface of the plane substrate, respectively.

FIG. 48 shows angle characteristics of reflectance of the plane-substrate side of the light-reducing films of the first modification example and of the second modification example.

FIG. 49 shows a wavelength characteristic of refractive index of titanium dioxide (TiO₂).

FIG. 50 shows a wavelength characteristic of the extinction coefficient of titanium dioxide (TiO₂).

FIG. 51 is a chart showing the film structure of the light-reducing film of a third modification example of the eighth representative embodiment.

FIG. 52 shows a wavelength characteristic of transmittance of the light-reducing film of the third modification example of the eighth representative embodiment.

FIG. 53 shows wavelength characteristics of reflectance of the plane-substrate side of the light-reducing film of the third modification example of the eighth representative embodiment.

FIG. 54 is an external view of an eyeglass display of a ninth representative embodiment.

FIG. 55 is a detailed view of the optical system of the eyeglass display of the ninth representative embodiment.

FIG. 56 is a chart showing the film structure of the light-reducing films of the ninth representative embodiment.

FIG. 57 shows a wavelength characteristic of transmittance of the center areas of the light-reducing films and a wavelength characteristic of transmittance of the peripheral area of the light-reducing film.

FIG. 58 shows a wavelength characteristic of transmittance of the center area of the light-reducing films of a first modification example of the ninth representative embodiment.

FIG. 59 shows angle characteristics of reflection of the plane-substrate side of the light-reducing film of the first modification example of the ninth representative embodiment (characteristics of the center area).

FIG. 60 is a view for explaining a first exposure in the manufacture of a holographic optical film.

FIG. 61 is a view for explaining a second exposure in the manufacture of the holographic optical film.

FIG. 62 is an embodiment of an eyeglass display of a tenth representative embodiment.

FIG. 63 is a detailed view of an optical system of the eyeglass display of FIG. 62.

FIG. 64 is a chart showing a correlation between the extinction coefficient k and transmittance of a glass substrate having a refractive index of 1.50 and a thickness of 1 mm.

FIG. 65 shows wavelength characteristics of reflectance of the plane-substrate side of the first optical film.

FIG. 66 shows angle characteristics of reflectance of the second plane-substrate side of the first optical film.

### DETAILED DESCRIPTION

### First Representative Embodiment

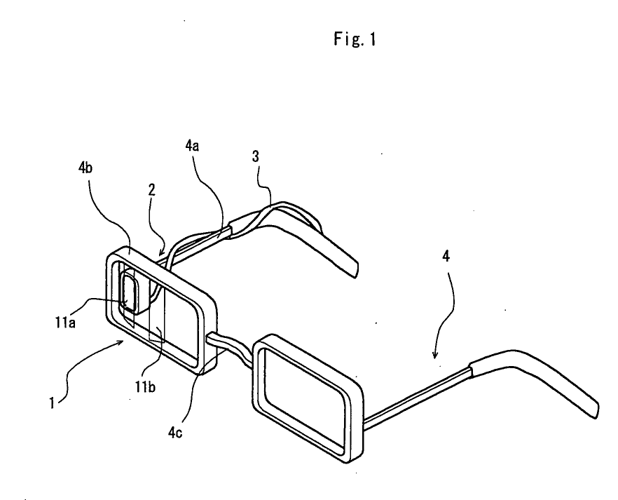

A first representative embodiment is described with reference to FIGS. 1-4. This embodiment is directed to an eyeglass display (corresponding to an image-display unit in the claims). First, the structure of the eyeglass display will be described.

As shown in FIG. 1, the eyeglass display includes an image-display optical system 1, an image-introduction unit 2, and a cable 3. The image-display optical system 1 and the image-introduction unit 2 are supported by a support member 4 that is similar to an eyeglass frame and that is worn on the head of a viewer (the support member 4 includes a temple 4a, a rim 4b, and a bridge 4c). The image-display optical system 1 has an external appearance similar to that of an eyeglass lens, and its periphery is supported by the rim 4b. The image-introduction unit 2 is supported by the temple 4a. The image-introduction unit 2 is supplied with image signals and power via the cable 3 from an external device.

When the eyeglass display is worn, the image-display optical system 1 is disposed in front of one of the wearer's eyes (hereinafter, assumed to be the right eye, which is referred to as “a viewing eye”) of the viewer. Below, the eyeglass display worn by the viewer is described with reference to the position of the viewer and the viewing eye.

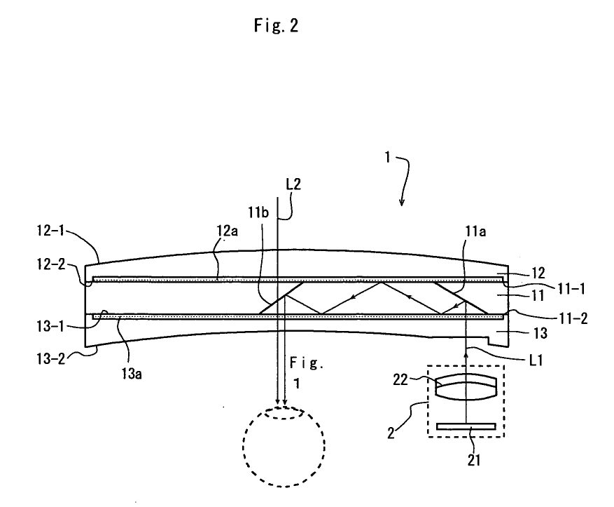

As shown in FIG. 2, the image-introduction unit 2 comprises a liquid-crystal display element 21 (corresponding to the image-display element in the claims) that displays images based on image signals supplied to it via the cable 3; and an objective lens 22 having its focal point located near the liquid-crystal display element 21. The image-introduction unit 2 radiates an image-carrying light flux L1 (visible light), which has exited the objective lens 22, to a right-end portion of a viewer-side surface of the image-display optical system 1.

The image-display optical system 1 comprises a plane substrate 13, a plane substrate 11, and a plane substrate 12 which are stacked in close contact in order from the viewer side. Each of the plane substrate 13, the plane substrate 11, and the plane substrate 12 is made of a material that is transmissive at least to visible light (for example, optical glass). Among them, the plane substrate 11 is a plane-parallel plate that repeatedly produces an internal reflection of the image-carrying light flux L1 introduced from the image-introduction unit 2. The internal reflection occurs on an external-side surface 11-1 and a viewer-side surface 11-2 (corresponding to the plane substrate in the claims). The plane substrate 12, disposed on the external side of the plane substrate 11, performs the function of diopter correction of the viewing eye. The plane substrate 12 is a lens of which the viewer-side surface 12-2 is flat and the external-side surface 12-1 is curved. The plane substrate 13, disposed on the viewer-side of the plane substrate 11, also performs diopter correction of the viewing eye. The plane substrate 13 is a lens of which the external-side surface 13-1 is flat and the viewer-side surface 13-2 is curved.

The area in the surface 13-2 through which the image-carrying light flux L1 first passes is a flat surface having no optical power for the image-carrying light flux L1. In an area on which the image-carrying light flux L1 is first incident inside the plane substrate 11, is a guide mirror 11a that changes the angle of the image-carrying light flux L1 to an angle allowing the flux to be internally reflected in the plane substrate 11.

In an area in the plane substrate 11, facing the pupil of the viewing eye, is a half-mirror 11b (corresponding to the combiner in the claims) that reflects the image-carrying light flux L1, which has been internally reflected, in a direction of the pupil. As an alternative to the half-mirror 11b, a HOE (holographic optical element) can be used. The HOE has a property of polarizing, in a specified direction, light that matches a specified diffraction condition. The combiner may have an optical power.

Between the plane substrate 12 and the plane substrate 11 is disposed a substituted film 12a that is in close contact with both plane substrates. Between the plane substrate 13 and the plane substrate 11 is disposed a substituted film 13a that is in close contact with both plane substrates (the substituted films 12a, 13a correspond to the optical-function unit in the claims). Each of the substituted films 12a, 13a has a property of reflecting visible light incident thereon at an approximately 60° angle of incidence, and of transmitting visible light that is incident thereon at an approximately 0° angle of incidence.

Next, details of the disposition of respective surfaces of the image-display optical system 1 will be described based on the behavior of the image-carrying light flux L1. As shown in FIG. 2, the image-carrying light flux L1 radiated from a display screen of the liquid-crystal display element 21 in the image-introduction unit 2 (only an image-carrying light flux of a center angle of view is shown) enters the plane substrate 13 via the objective lens 22 at an approximately 0° angle of incidence. Thus, the image-carrying light flux L1 passes through the substituted film 13a to be incident on the plane substrate 11. The image-carrying light flux L1 entering the plane substrate 11 is incident on the guide mirror 11a at a specified angle of incidence and is reflected thereby. The reflected image-carrying light flux L1 is incident on the substituted film 13a at an angle of incidence (θ) of approximately 60°. Hence, the light flux is reflected by the substituted film 13a toward the substituted film 12a. The image-carrying light flux L1 is incident also on the substituted film 12a at the angle of incidence θ. Hence, the light flux is reflected also by the substituted film 12a.

Therefore, the image-carrying light flux L1 propagates to the viewer's left away from the image-introduction unit 2 while repeating the reflections alternately on the substituted films 13a, 12a. Thereafter, the image-carrying light flux L1 is incident on the half-mirror 11b for reflection toward the pupil of the viewing eye. The reflected image-carrying light flux L1 is incident on the substituted film 13a at an approximately 0° angle of incidence and thus passes through the substituted film 13a to be incident, via the plane substrate 13, on the pupil of the viewing eye.

An external light flux L2 from an external field (relatively distant point) is incident on the substituted film 12a, via the plane substrate 12, at an approximately 0° angle of incidence. The light flux L2 passes through the substituted film 12a and is incident, via the plane substrate 11, on the substituted film 13a at an approximately 0° angle of incidence. The external light flux L2 passes through the substituted film 13a to be incident, via the plane substrate 13, on the pupil of the viewing eye. Here, the respective shapes of the external-side surface 12-1 of the plane substrate 12 and of the viewer-side surface 13-2 of the plane substrate 13 are set so as to make the desired diopter correction of the viewing eye.

The diopter correction of the viewing eye for the external field is realized by a combination of the respective shapes of the surface 12-1 and of the surface 13-2 that are disposed in the light path of the external light flux L2. The diopter correction of the viewing eye for an image is realized by the shape of the surface 13-2 disposed in the optical path of the image-carrying light flux L1. To realize the diopter correction of the viewing eye for an image, the position of the objective lens 22 in an optical-axis direction and the position of the liquid-crystal display element 21 in the optical-axis direction can be adjusted.

In the eyeglass display described above, the elements disposed in the optical path from the liquid-crystal display element 21 to the pupil correspond to the combiner optical system in the claims.

The substituted films 12a, 13a are now described in detail.

The inner total reflection in the plane substrate 11, disposed in a medium, generally occurs when an angle of incidence exceeds a critical angle θ_{c} expressed by the Equation (1):
θ_{c}=arcsin [nₘ/n_{g}] (1)
where nₘ is the refractive index of the medium, and n_{g} is the refractive index of the plane substrate 11. Equation (1) shows that nₘ<n_{g} must hold for θ_{c} to exist. Therefore, direct adhesion of the plane substrates 12, 13 on the respective surfaces of the plane substrate 11 would make the refractive index of the medium too high for θ_{c} to exist, which would damage the inner-surface reflection function.

On the other hand, if air gaps are provided adjacent the respective surfaces of the plane substrate 11, the low refractive index (nₘ=1.0) of the air medium facilitates achievement of the inner-surface reflection function because Equation (1) provides the critical angle θ_{c} of about 40° when the material of the plane substrate 11 is made (as typically) of optical glass BK7 (n_{g}=1.56).

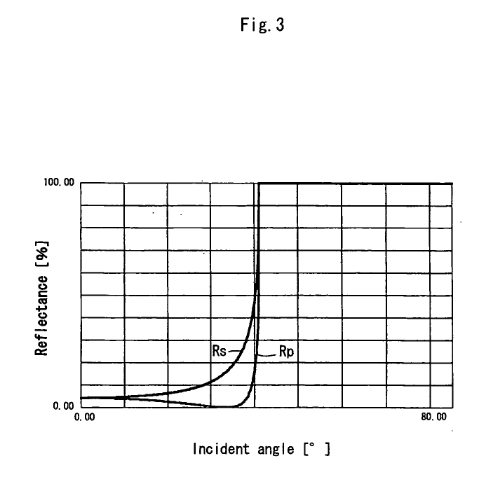

The incidence-angle characteristics of reflectance of the plane substrate 11 whenever an air gap is present are shown in FIG. 3.

Regarding a dielectric optical multilayer film, the following relationships are obtained from the theory of dielectric optical multilayer films. Namely, a film structure (to be described below) of a symmetric film made of a dielectric optical multilayer film, sandwiched by a plane substrate, and a plane substrate each made of optical glass will be discussed. Here, a symmetric film refers to a film structure in which layers of various kinds are stacked centro-symmetrically. Generally, a layer group as one unit is expressed in parentheses, which also sets forth its structure (the same convention is used in the following description):

plane substrate/(0.125L, 0.25H, 0.125L)^{k}/plane substrate, or

plane substrate/(0.125H, 0.25L, 0.125H)^{k}/plane substrate

In each of these layer groups, H represents a high-refractive index layer, L represents a low-refractive index layer, the right superscript k of each layer group represents the number of stacks of each layer group, and the numeral written before each layer represents the optical-layer thickness for a center wavelength (nd/λ) of light that is incident on the respective layer (the same applies to the description below).

A symmetric film can be handled as an equivalent single film (equivalent film) having a virtual refractive index. The theory of the relationship between the symmetric film and the equivalent refractive index (equivalent refractive index) of this film is described in detail in MacLeod, Thin-Film Optical Filters, 3^{rd} Edition. Hence, detailed descriptions of this theory are omitted below.

In this film structure, if an equivalent refractive index of the equivalent film for vertically incident light is set to the same refractive index as that of the plane substrate 11, the equivalent film causes no interface reflection of vertically incident light. Thus, the film has 100% transmittance for vertically incident light, but exhibits interface reflection of light at a large angle of incidence. Thus, the film has increased reflectance for this light, because an apparent refractive index N of a dielectric generally changes as follows in accordance with a propagation angle θ of light in the dielectric:
N=n cos θ(s-polarized light)
N=n/cos θ(p-polarized light)
Note that n is the refractive index of the dielectric. The incremental amount of reflectance in accordance with the increase in the angle of incidence is especially noticeable for the s-polarized light.

Regarding the structure of the substituted films 12a, 13a, it is necessary for the substituted films 12a, 13a not to damage the inner reflection function of the plane substrate 11 and of the see-through feature (=external visibility) of the plane substrate 11, as mentioned in (1). That is, the substituted films need to reflect the image-carrying light flux L1 and to transmit the external light flux L2. Therefore, the substituted films 12a, 13a are configured to reflect, with high reflectance (preferably total reflection), light that is incident thereon at a critical angle or at a larger angle than the critical angle. The critical angle is determined by a difference in refractive index between the plane substrate 11 and air.

In this embodiment, the property of the substituted films 12a, 13a is set so as to “reflect visible light that is incident thereon at an approximately 60° angle of incidence and transmit visible light that is incident thereon at an approximately 0° angle of incidence.” This property can be obtained by the dielectric optical multilayer film described in (2). As a result, in this embodiment, dielectric optical multilayer films are used as the substituted films 12a, 13a.

The substituted films 12a, 13a can be configured as follows. The structure of the substituted films 12a, 13a (i.e., the structure of a unit layer group, the number of stacks, the layer thickness of each layer, the refractive index of each layer, the material of each layer, etc.) is optimized according to the angle of incidence (here, 60°) of light for which high reflectance has to be exhibited. The refractive index of the plane substrate 11 is optimized at the same time. The basic structure of the substituted films 12a, 13a is the symmetric film described in (2). However, even when the theory described in (2) is applied, the resultant solution and the refractive index of the existing thin-film material scarcely match each other. Hence, all or part of the following measures is taken in configuring the films.

A first measure is to insert several layers (matching layers) on the plane side of the substrate 11 for the purpose of realizing matching with the plane substrate 11. A second measure is to absorb refractive-index dispersion among materials and make fine adjustment of a spectral characteristic/angle characteristic of reflectance/transmittance of the materials at the time of the optimization. A third measure is to break symmetry (allow asymmetry) as required. A fourth measure is to utilize optimized design of layer thickness and automatic synthesis of the film structure as determined by a computer. A fifth measure is to configure the films to have a desired characteristic only for s-polarized light (because the dielectric optical multilayer film has a property in which an incremental amount of its reflectance accompanying an increase in angle of incidence is especially noticeable for s-polarized light). A sixth measure is to configure the films to exhibit a desired characteristic only for a specified wavelength.

The fifth measure is effective whenever the light source for the liquid-crystal display element 21 (FIG. 2) is s-polarized. The fifth measure also can be made effective in the case of a p-polarized light source if the polarization direction thereof is rotated by a phase plate or the like. Limiting the polarization direction is advantageous because the degrees of freedom with which the films can be configured are accordingly enhanced.

The sixth measure is effective whenever the light source for the liquid-crystal display element 21 (FIG. 2) emits light having a specific wavelength. Limiting the wavelength is advantageous because the degrees of freedom with which the films can be configured are accordingly enhanced.

Next, effects of the eyeglass display will be described. In the eyeglass display the substituted films 12a, 13a are formed on the external side and the viewer side, respectively, of the plane substrate 11. The properties of the substituted films 12a, 13a are established so that the films reflect visible light that is incident thereon at an angle of incidence of approximately 60° and transmit visible light that is incident thereon at an angle of incidence of approximately 0°. The plane substrate 11 sandwiched by these substituted films 12a, 13a can cause inner-surface reflection of the image-carrying light flux L1 and can transmit the external light flux L2 from the external field (far point). Hence, even though the plane substrates 12, 13 (having substantially the same refractive index as of the plane substrate 11) are adhered to the plane substrate 11, the inner-surface reflection function and the see-through feature of the plane substrate 11 are not compromised at all. Thus, it is possible for the eyeglass display to provide diopter correction by the simple method of adhering the substrates 12, 13.

Using a light-absorbing material for the plane substrates 12, 13 enables the eyeglass display to function as sunglasses. In the event only a sunglass function is necessary and diopter correction is not required, the plane substrates 12, 13 may be light-absorbent plane-parallel plates.

In this embodiment, the image-carrying light flux L1 is visible light and the plane substrate 11 and substituted films 12a, 13a are configured to exhibit inner-surface reflection of visible light. In general, when the light source of the liquid-crystal display element 21 has an emission spectrum, the configuration may be set to exhibit inner-surface reflection at least of light having a peak wavelength thereof.

In the eyeglass display of this embodiment, the diopter correction is realized by the two plane substrates (plane substrates 11, 12) and the two substituted films (substituted films 12a, 13a). Alternatively, the diopter correction may be realized by one plane substrate and one substituted film.

In this embodiment, the dielectric optical multilayer films are used as the substituted films 12a, 13a. Alternatively, HOEs may be used. Details of the structure of the substituted films 12a, 13a using the dielectric optical multilayer film will be described later below, but a manufacturing method involving a HOE is described below.

FIG. 4 shows an optical system for manufacturing the HOE. This optical system provides a HOE that reflects, with high reflectance, the image-carrying light flux L1 that is incident thereon at the incidence angle θ. A laser beam having wavelength λ radiated from a laser-light source 31 is split into two beams by a beam-splitter 32. The two split laser beams are expanded by respective beam-expanders 33 and then are incident on a hologram-photosensitive material 35 via respective auxiliary prisms 34. Consequently, the photosensitive material 35 is exposed. Here, the incidence angle of the laser beams on the photosensitive material 35 is set to θ. The photosensitive material 35 is developed, thereby completing the HOE.

The completed HOE causes diffraction/reflection of a light flux, having the specified wavelength λ, that is incident thereon at the specified angle θ, and totally transmits light that is incident thereon at an approximately 0° angle of incidence.

The incident angle and wavelength of light for which the substituted films 12a, 13a exhibit a reflective property are not of one kind. Hence, the photosensitive material 35 is subjected to multiple exposures while the angle θ and the wavelength λ of the laser beam are varied as required.

Using a resin-based material (resin sheet) as the hologram-photosensitive material 35 enables low-cost manufacture of a HOE having a large area. If the HOE is the resin sheet, it is possible to bring the HOE into close contact with the plane substrate 11 of the eyeglass display only by adhering the HOE, which has a high practical value in terms of cost-reduction and mass-production.

Alternatively, each of the substituted films 12a, 13a of this embodiment can be configured as respective optical multilayer films made of a metal film, a semiconductor film, or the like. However, a dielectric optical multilayer film is desired because it absorbs less light than an optical multilayer film.

Desirably, the optical-function units described above (i.e., the dielectric optical multilayer film, the HOE, and the other optical multilayer films) are selectively used as the substituted films 12a, 13a according to the specifications and cost of the eyeglass display.

### EXAMPLE 1

A first example of the substituted films 12a, 13a made of respective dielectric optical multilayer films will be described. This example is effective whenever the light source of the liquid-crystal display element 21 is polarized. The basic structure of this example is as follows, for instance:

plane substrate/(0.125L, 0.25H, 0.125L)^{k}/plane substrate

In this example the refractive index of the plane substrates is 1.74, the refractive index of the high-refractive index layers H is 2.20, and the refractive index of the low-refractive index layers L is 1.48. The plane substrates were made of N-LAF35 manufactured by SCHOTT. One of TiO₂, Ta₂O₅, and Nb₂O₅ was used to form the high-refractive-index layers H under an adjusted film-deposition condition, and SiO₂ was used to form the low-refractive-index layers.

The dielectric optical multilayer film with this basic structure is generally called “a short-wavelength transmission filter.” It exhibits high transmittance for light having a wavelength shorter than a specified wavelength and exhibits high reflectance for light having a wavelength longer than the specified wavelength. Another characteristic of a general dielectric optical multilayer film is that its spectral characteristic shifts to the short-wavelength side according to the incidence angle when light is obliquely incident thereon. By combining these two characteristics, the transmission band of vertically incident light matches the entire visible spectrum (400˜700 nm) in advance, and the basic structure is optimized so that a long-wavelength-side reflection band matches the entire visible spectrum (400˜700 nm) when the incidence angle approaches the critical angle θ_{c} of the plane substrate 11. As a result of this optimization, this example has the following structure:

plane substrate/(0.125L, 0.28H, 0.15L)(0.125L, 0.25H, 0.125L)⁴(0.15L, 0.28H, 0.125L)/plane substrate

The refractive index of the plane substrates is 1.56, the refractive index of the high-refractive-index layers H is 2.30, the refractive index of the low-refractive-index layers L is 1.48, and the center wavelength λ is 850 nm.

As the plane substrates, N-BAK4, manufactured by SCHOTT, was used. The high-refractive-index layers H were formed of one of TiO₂, Ta₂O₅, and Nb₂O₅ under an adjusted film-deposition condition.

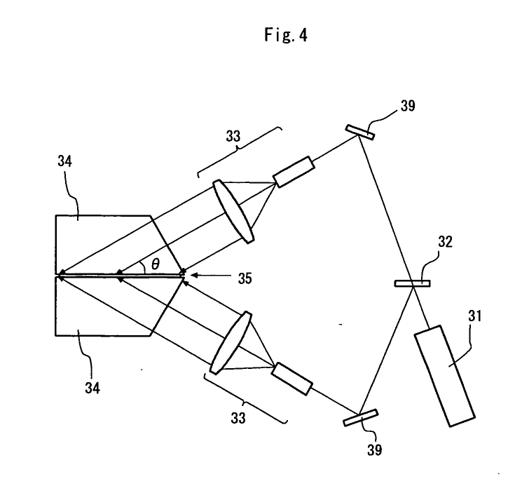

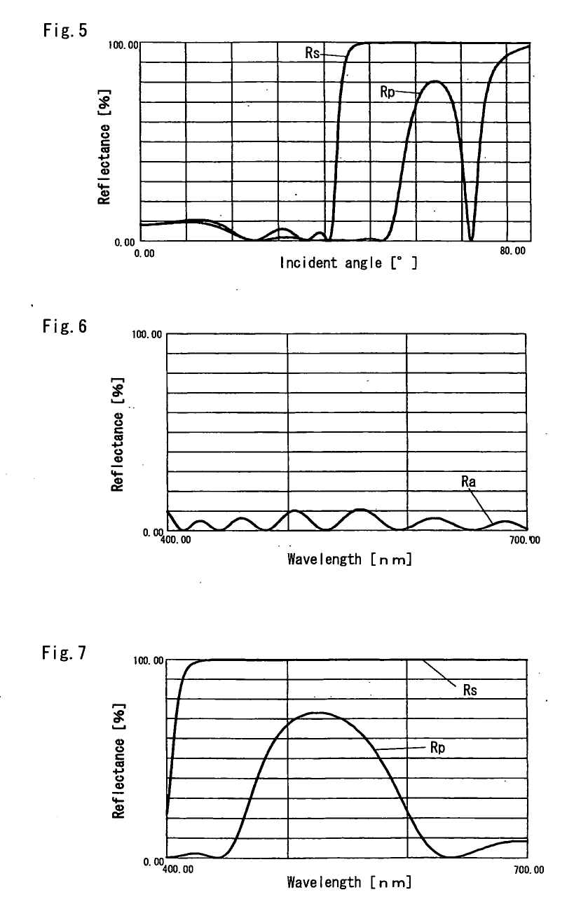

FIGS. 5-7 depict the angle characteristics of reflectance, the wavelength characteristics of reflectance for vertically incident light, and the wavelength characteristics of reflectance for light that is incident at 60°, respectively, in this Example. In the drawings described below, Rₛ is the reflectance characteristic for s-polarized light, Rₚ is the reflectance characteristic for p-polarized light, and Rₐ is the average reflectance characteristic for s-polarized light and p-polarized light. As shown in FIG. 5, the angle characteristic of reflectance of this example, when limited to s-polarized light, well matches the angle characteristic of reflectance of the glass substrate (see FIG. 3). As shown in FIG. 6, this example exhibits high transmittance for vertically incident visible light. As shown in FIG. 7, this example exhibits substantially 100% reflectance for light, in substantially the entire visible spectrum, that is incident at 60°.

In this example, the matching layers serve, for example, to reduce ripples in the transmission band (wavelength range for which reflectance is low).

### EXAMPLE 2

This example also pertains to the substituted films 12a, 13a made of the dielectric optical multilayer films. This example applies whenever the light source of the liquid-crystal display element 21 is polarized. The basic structure is as follows, for instance:

plane substrate/(0.125H, 0.25L, 0.125H)^{k}/plane substrate

This structure is generally called “a long-wavelength transmission filter.” It exhibits high transmittance for light having a wavelength longer than a specified wavelength and exhibits high reflectance for light having a wavelength shorter than the specified wavelength.

As a result of optimization, this example had the following structure:

plane substrate/(0.3H, 0.27L, 0.14H)(0.1547H, 0.2684L, 0.1547H)3(0.14H, 0.27L, 0.3H)/plane substrate

The refractive index of the plane substrates is 1.56, the refractive index of the high-refractive-index layers H is 2.00, the refractive index of the low-refractive-index layers L is 1.48, and the center wavelength λ is 750 nm.

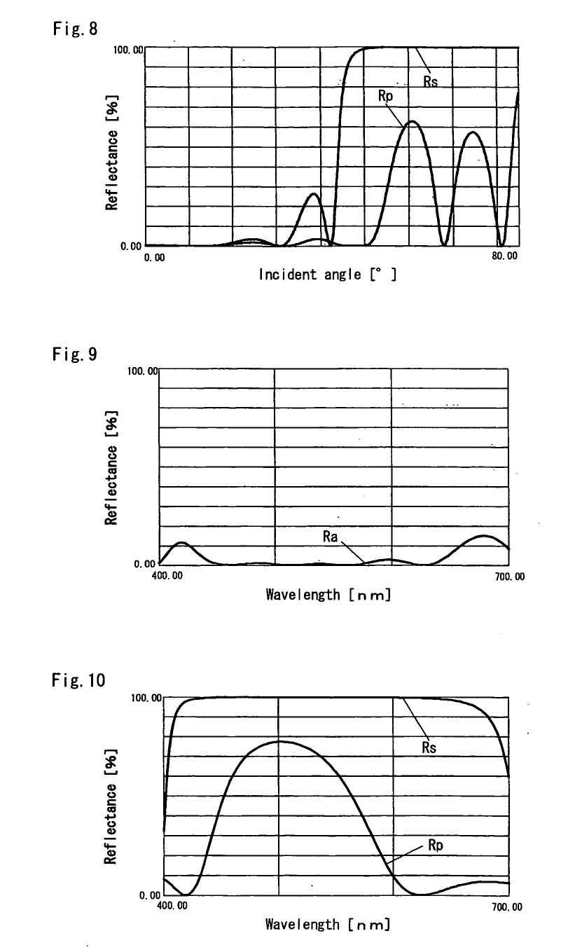

One of ZrO₂, HfO₂, Sc₂O₃, Pr₂O₆, and Y₂O₃ was used to form the high-refractive-index layers H under an adjusted film-deposition condition. The same materials as those in the example previously described were used for the plane substrates and the low-refractive-index layers L. As shown in FIGS. 8-10, for s-polarized light, this example provides good characteristics that are substantially the same as of Example 1.

In this example, a long-wavelength transmission filter was used as the basic structure. According to the theory described in (2), a short-wavelength-transmission filter is suitable. But, according to studies based on refractive indices of existing thin-film materials, the basic structure thus using the long-wavelength-transmission filter often provides a design solution.

### EXAMPLE 3

This example pertains to the substituted films 12a, 13a made of the dielectric optical multilayer films. This example is applicable when the light source of the liquid-crystal display element 21 is not polarized. As a result of optimization, this example had the following structure:

plane substrate/(0.25H, 0.125L)(0.125L, 0.25H, 0.125L)⁴(0.125L, 0.25H)/plane substrate

The refractive index of the plane substrates is 1.75, the refractive index of the high-refractive-index layers H is 2.30, the refractive index of the low-refractive-index layers L is 1.48, and the center wavelength λ is 1150 nm.

As the plane substrates, N-LAF4, manufactured by SCHOTT, was used. The high-refractive-index layers H were formed of one of TiO₂, Ta₂O₅, and Nb₂O₅ under an adjusted film-deposition condition, and SiO₂ was deposited to form the low-refractive-index layers L.

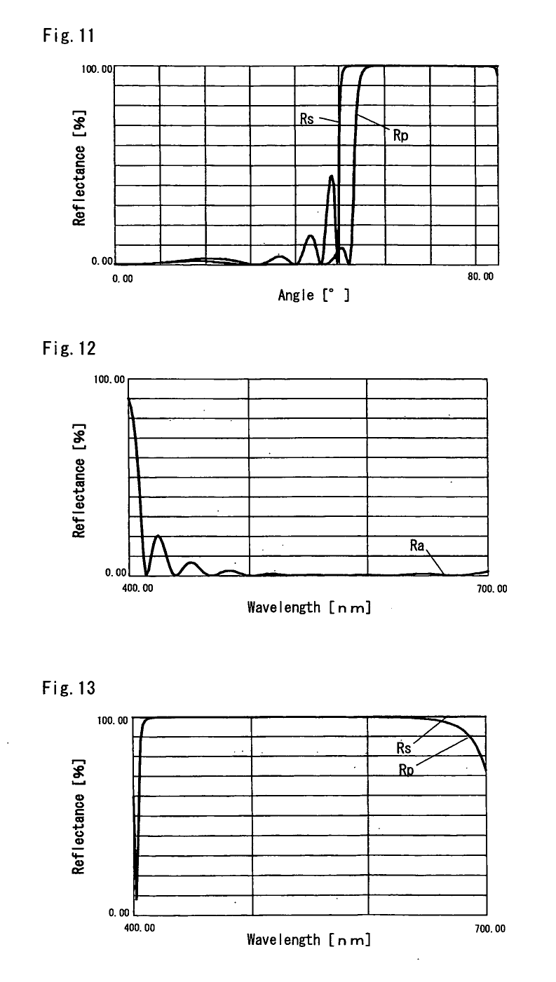

FIGS. 11-13 show the angle characteristics of reflectance, the wavelength characteristics of reflectance for vertically incident light, and the wavelength characteristics of reflectance for light that is incident at 60°, respectively, in this example. As shown in FIGS. 11-13, according to this example, good characteristics are exhibited for both p-polarized light and s-polarized light.

The structure of this example has the following symmetric structure:

plane substrate/(matching layer group I)^{k1}·(symmetric layer group)^{k2}·(matching layer group II)^{k3}/plane substrate

Each layer group is made of repeated stacks of a low-refractive-index layer L and a high-refractive-index layer H (LHL or HLH), and exhibits increased reflectance for light at 60° incidence. The center layer group tends to reflect vertically incident light. Hence, to reduce this reflection, the layer thickness of each layer in the matching layer groups I, II is adjusted by optimization.

In configuring this example, the numbers of stacks k1, k2, k3 of the respective layer groups are increased/decreased and the layer thickness of each layer in the matching layer groups I, II is adjusted according to the incidence angle of light and the refractive index of the plane substrates.

In a case in which the relation with one of the plane substrates and the relation with the other plane substrate are different (such as where the two plane substrates are different in refractive index or an adhesive layer is interposed between this example and only one of the plane substrates), the numbers of stacks of the matching layer groups I, II and the thickness of each layer may be individually adjusted.

Currently, in wide use are computerized methods for obtaining optimized designs of layer thicknesses and automatic synthesis of the film structures. When a computer method is used, an obtained design solution sometimes deviates slightly from the above-described basic structure. However, this can be considered as the basic structure with part thereof being adjusted (modified basic structure).

### EXAMPLE 4

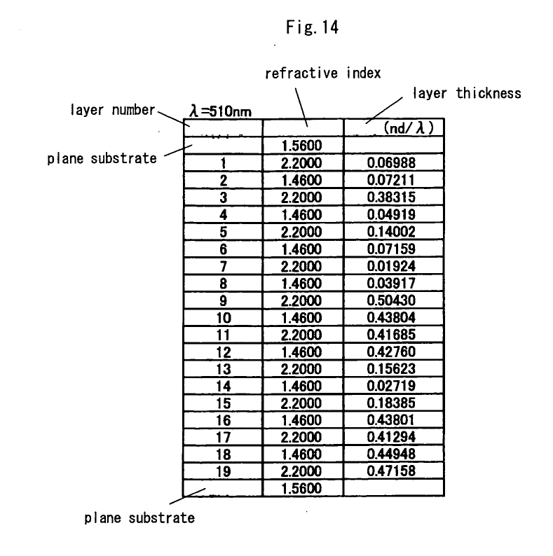

This fourth example is directed to the substituted films 12a, 13a made of the dielectric optical multilayer films. This example is applicable when the light source of the liquid-crystal display element 21 is polarized. Further, this example also is applicable to situations in which automatic synthesis of the film structure is performed using a computer is applied. The basic structure of this example is shown in FIG. 14, in which the total number of layers is 19, the refractive index of the plane substrates is 1.56, the refractive index of the high-refractive-index layers H is 2.20, the refractive index of the low-refractive-index layers L is 1.46, and the center wavelength λ is 510 nm. As the plane substrates, N-BAK4, manufactured by SCHOTT, was used, and the same high-refractive-index layers H as those of Example 1 were used. SiO₂ was used to form the low-refractive-index layers L under an adjusted film-deposition condition.

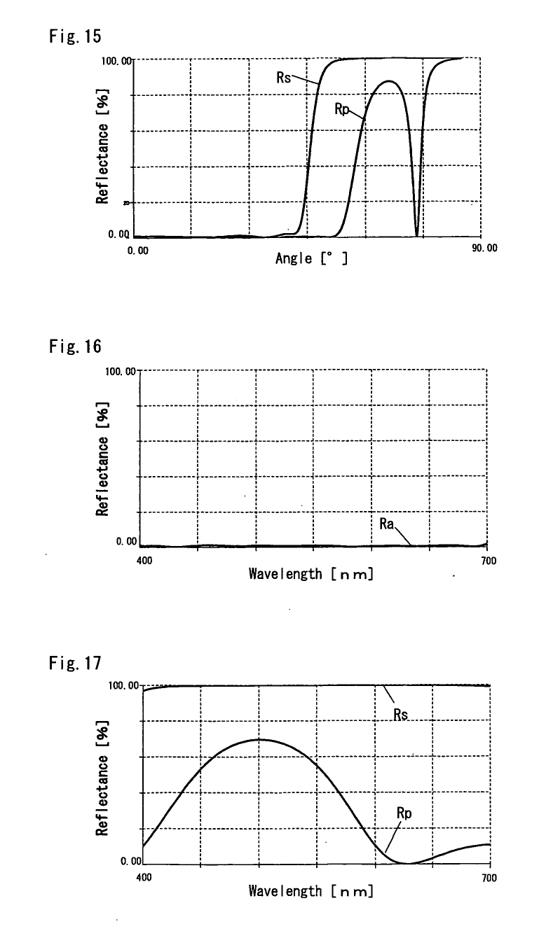

FIGS. 15-17 depict the angle characteristics of reflectance, the wavelength characteristics of reflectance for vertically incident light, and the wavelength characteristics for reflectance for light at 60° incidence, respectively, in this example. As shown in FIGS. 15-17, according to this example, good characteristics are exhibited. Especially, as shown in FIG. 16, transmittance for vertically incident light is highly improved.

### EXAMPLE 5

This example pertains to the substituted films 12a, 13a made of the dielectric optical multilayer films. This example is applicable when the light source of the liquid-crystal display element 21 is not polarized. This example is also applicable to automatically synthesizing the film structure using a computer.

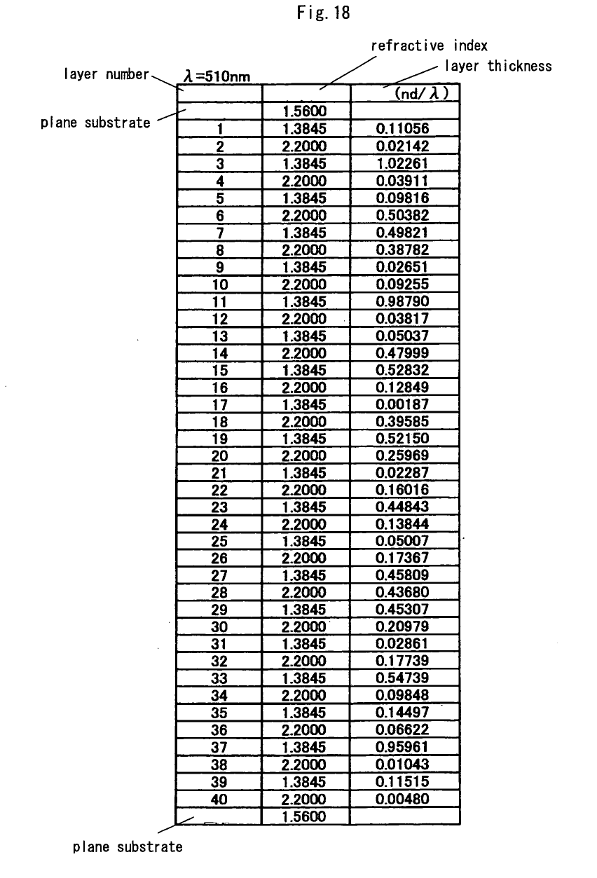

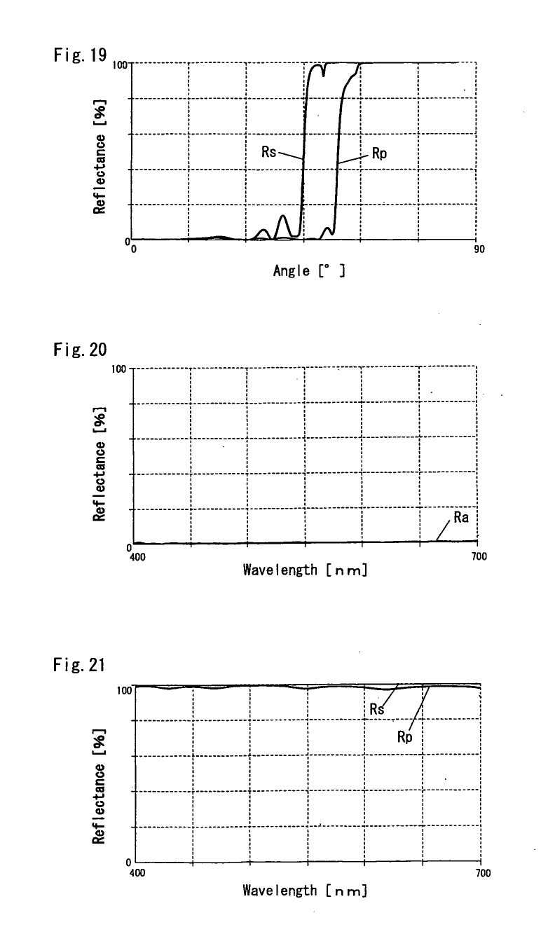

The basic structure of this example is shown in FIG. 18, in which the total number of layers is 40, the refractive index of the plane substrates is 1.56, the refractive index of the high-refractive-index layers H is 2.20, the refractive index of the low-refractive-index layers L is 1.3845, and the center wavelength λ is 510 nm. As the plane substrates, N-BAK4, manufactured by SCHOTT, was used. Also, the same high-refractive-index layers H as those of the first example were used, and one of MgF₂ and AlF₂ was used to form the low-refractive-index layers L. FIGS. 19-21 show the angle characteristics according to this example, good characteristics are exhibited. Especially as shown in FIGS. 20 and 21, transmittance for vertically incident light and reflectance for 60° incident light are improved.

### Second Representative Embodiment

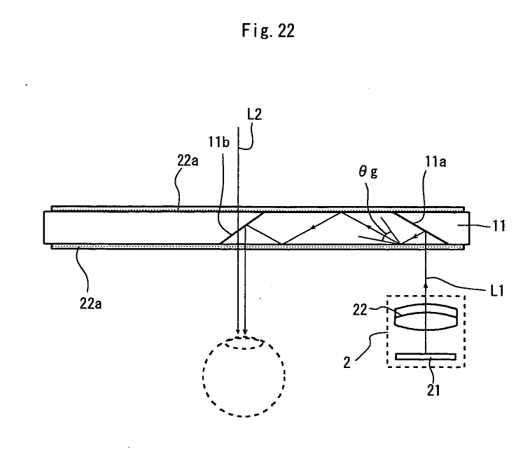

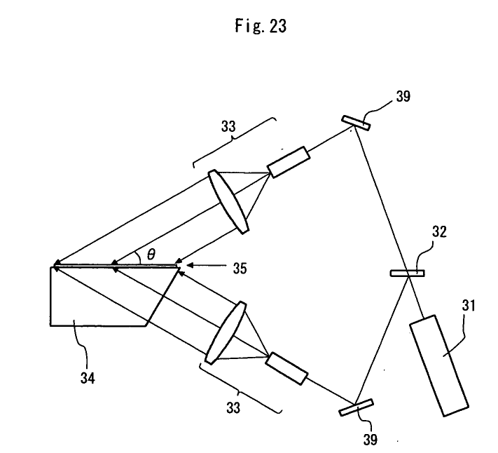

A second representative embodiment is described with reference to FIGS. 22 and 23. This embodiment is directed to an eyeglass display. In the following, features that are different from corresponding features in the first embodiment are mainly described.

FIG. 22 is a schematic cross-sectional view of the optical-system portion of the eyeglass display, taken along a horizontal plane of a viewer. The optical-system portion of the eyeglass display includes an image-introduction unit 2 and one plane substrate 11 (the image-introduction unit 2 has a liquid-crystal-display element 21 and an objective lens 22 mounted therein, and the plane substrate 11 has a guide mirror 11a and a half-mirror 11b installed therein).

In the eyeglass display, reinforcing reflective films 22a are provided respectively on a viewer-side surface and an external-side surface of the plane substrate 11. The reinforcing reflective films 22a are in close contact with the respective surfaces of the plane substrate 11. Each of the reinforcing reflective films 22a has at least the same function as that of the substituted films 12a, 13a (i.e., the same function as an air gap). Specifically, the reinforcing reflective film 22a exhibits a reflective property for an image-carrying light flux L1 (here, visible light that is incident at an incidence angle of approximately 60°) that should be inner-surface reflected in the plane substrate 11. The reinforcing reflective film 22a also exhibits a transmissive property for the image-carrying light flux L1 that should pass through the plane substrate 11 for an external light flux L2 (here, visible light that is incident at an incidence angle of approximately 0°).

The range of incidence angle of visible light that the reinforcing reflective film 22a can reflect is wider than the range of incidence angle for visible light that the substituted films 12a, 13a can reflect. Specifically, the lower limit of the range of incidence angle is smaller than the critical angle θ_{c} (≈40°) of the plane substrate 11. The lower limit is set, for example, to 35° or the like (the upper limit of the range of incidence angle θ_{g} is approximately 90°, similar to that of each of the substituted films 12a, 13a and the plane substrate 11 as a single element in air.

The range of incidence angle θ_{g} of the image-carrying light flux 11 (that the plane substrate 11 having the reinforcing reflective film 22a thereon can inner-surface reflect) is larger than the range when the plane substrate 11 exists in the air as a single element. The widened range of incidence angle θ_{g} results in a widened angle of view of an image that can be viewed by the viewing eye.

If the lower limit of the range of incidence angle of visible light reflectable by the reinforcing reflective film 22a is set too low, the following problem can arise. That is, there is a possibility that part of the external light flux L2 cannot pass through the reinforcing reflective film 22a, resulting in poor external visibility. There is also the possibility that part of the image-carrying light flux L1 polarized by the half-mirror 11b cannot be radiated to an external location (exit pupil) from the plane substrate 11, resulting in a loss. Therefore, the lower limit of the range of incidence angle of visible light that can be reflected by the reinforcing reflective film 22a desirably is set to appropriately 0° to θ_{c}, taking into consideration the angle of view of the image-carrying light flux L1 and the incidence angle thereof at the time of its inner-surface reflection.

A reinforcing reflective film 22a having such a characteristic is made of a dielectric optical multilayer film, a HOE (holographic optical element), or the like. The structure of the reinforcing reflective film 22a that includes the dielectric optical multilayer film will be described in detail in a later example. The method of manufacturing the HOE (see FIG. 23) is basically the same as described in the first representative embodiment (see FIG. 4). However, in FIG. 23, it is necessary to insert the auxiliary prism 34 only in one of the laser beams that is incident on the photosensitive material 35. This is because one of the two media in contact with the reinforcing reflective film 22a of this embodiment is air.

The value of the angle θ (angle of incidence of the laser beam on the hologram photosensitive material 35) in the system of FIG. 23 falls within the range of incidence angle of light for which the reinforcing reflective film 22a should exhibit a reflective property. The incidence angle and wavelength of light for which the reinforcing reflective film 22a should exhibit a reflective property are not of one kind. Hence, the photosensitive material 35 is subjected to multiple exposures while the angle θ and the wavelength of the laser beam are varied.

Use of a resin-based material (resin sheet) as the hologram photosensitive material 35 enables low-cost manufacture of a HOE having a large area. If the HOE is the actual resin sheet, it is possible to bring the HOE into close contact with the plane substrate 11 of the eyeglass display only by adhering the HOE. This is very practical in terms of cost reduction and mass production.

As the reinforcing reflective film 22a of this embodiment, an optical multilayer film made of a metal film, a semiconductor film, or the like may be used. However, compared with an optical multilayer film, the dielectric optical multilayer film absorbs less light and thus is more desirable.

Desirably, the optical-function components described above (i.e., the dielectric optical multilayer film, the HOE, and the other optical multilayer films) are selectively used as the reinforcing reflective film 22a according to the specifications, cost, and the like of the eyeglass display.

### EXAMPLE 6

This example is an example of the dielectric optical multilayer film that is suitable for use as the reinforcing reflective film 22a of the eyeglass display of the second representative embodiment. In this example, it is premised that the light source of the liquid-crystal display element 21 of the eyeglass display has an emission spectrum (including peaks in red (R) color, green (G) color, and blue (B) color, respectively), and that the light source of the liquid-crystal display element is polarized. This example also explores a method of automatically synthesizing the film structure by computer.

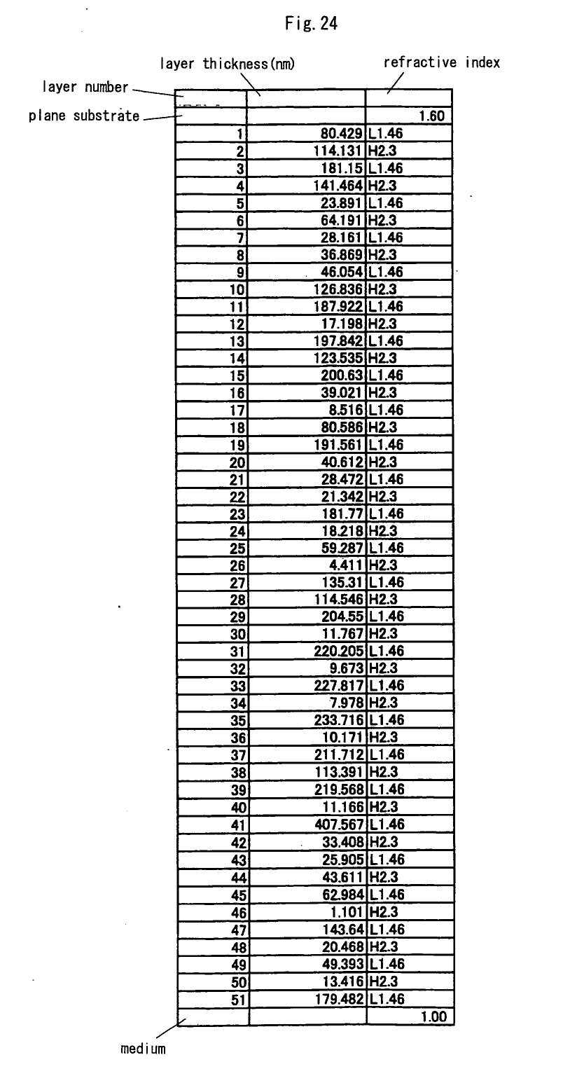

The film structure of the dielectric optical multilayer film of this example is shown in FIG. 24, in which the total number of layers is 51, the refractive index of the plane substrate 11 is 1.60, the refractive index of the high-refractive index layers is 2.3, and the refractive index of the low-refractive index layers is 1.46. N-SK14, manufactured by SCHOTT, was used as the plane substrate. TiO₂, Ta₂O₅, or Nb₂O₅ was used to form the high-refractive-index layers H under an adjusted film-deposition condition. SiO₂ was used to form the low-refractive-index layers under an adjusted film-deposition condition.

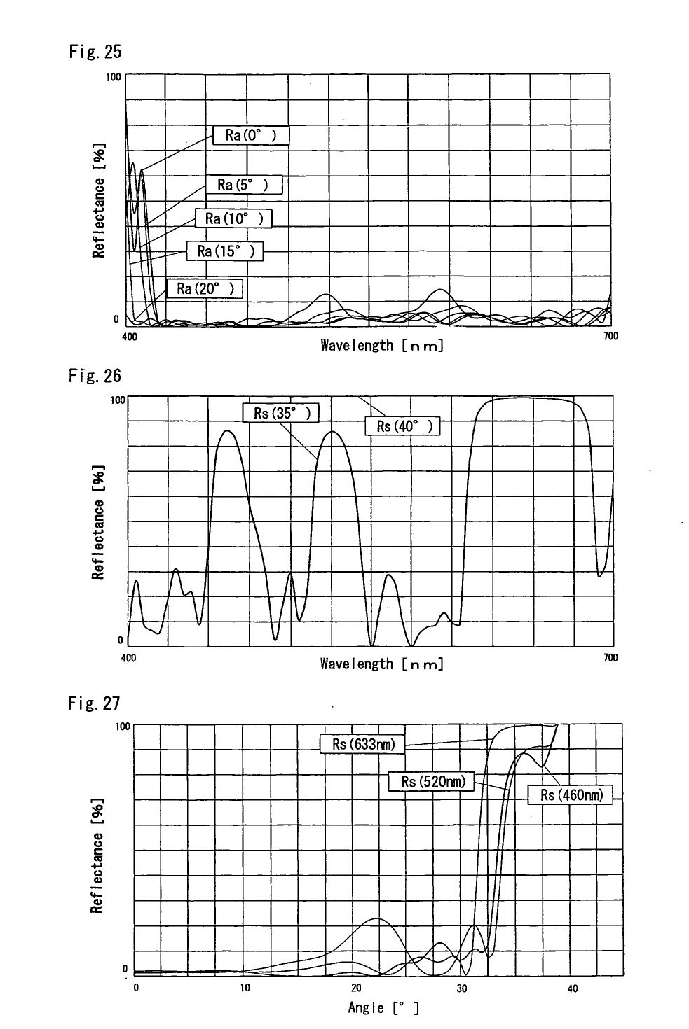

FIG. 25 depicts wavelength characteristics of reflectance of the dielectric optical multilayer film of this example for light at small incidence angles (incidence angles in the range of 0° to 20°). In FIG. 25, curves denoted Ra (0°), Ra (5°), Ra (10°), Ra (15°), and Ra (20°) are plots of respective reflectances for light that is incident at angles of 0°, 5°, 10°, 15°, and 20°, respectively (each being an average of reflectance for an s-polarized component of the incident light and of reflectance for a p-polarized component of the incident light). As apparent from FIG. 25, the dielectric optical multilayer film of this example exhibits a transmittance of 80% or higher for incident light in the entire visible spectrum if the incidence angles of the lights fall within 0° to 20°.

FIG. 26 is a plot of wavelength characteristics of reflectance of the dielectric optical multilayer film of this example for light at large incidence angles (incidence angles of 35° and 40°). In FIG. 26 Rs (35°) and Rs (40°) denote respective reflectances for light at incidence angles of 35° and 40°, respectively (each being the reflectance for an s-polarized component of the incident light). As apparent from FIG. 26, the dielectric optical multilayer film of this example exhibits a substantially 100% reflectivity for s-polarized light in the entire visible spectrum if its incidence angle is 40°. For s-polarized light at an incidence angle of 35°, the film exhibits a reflectivity of 80% or higher for respective components of R color, G color, and B color in the visible spectrum (460, 520, 633 nm, respectively).

FIG. 27 provides plots of the angle characteristics of reflectance of the dielectric optical multilayer film of this example for light of the respective denoted wavelengths. In FIG. 27, Rs (633 nm), Rs (520 nm), and Rs (460 nm) are reflectances for light (R color, G color, and B color) having wavelengths of 633 nm, 520 nm, and 460 nm, respectively. Each reflectance is for the s-polarized component of the incident light. As apparent in FIG. 27, the dielectric optical multilayer film of this example exhibits a reflectivity of 80% or higher for light of the respective components of R color, G color, and B color in the visible spectrum if the incidence angle is 35° or larger.

As noted, 35° is the lower limit of a range of incidence angle of visible light (here, s-polarized light of R color, G color, and B color) for which the dielectric optical multilayer film of this example exhibits reflectivity. This angle is smaller than the critical angle θ_{c}=38.7° of the plane substrate 11 (refractive index 1.60) assumed in this example. Hence, in the eyeglass display using the dielectric optical multilayer film of this example as the reinforcing reflective film 22a, the lower limit of the incidence angle range θ_{g} of the image-carrying light flux L1 that is internally reflected in the plane substrate 11 is reduced from the critical angle θ_{c}=38.7° to 35° by as much as 3.7°. As a result, the eyeglass display can transmit the image-carrying light flux L1 at an incidence angle within the range θ_{g}=35° to 65° (i.e., the image-carrying light flux L1 having a 30° angle of view.

As shown in FIG. 25, the dielectric optical multilayer film of this example has high transmittance for visible light at a small incidence angle (0° to 20°), which ensures external visibility of the eyeglass display. Also, there is no loss of the image-carrying light flux L1 that is incident on the exit pupil from the plane substrate 11.

### Third Representative Embodiment

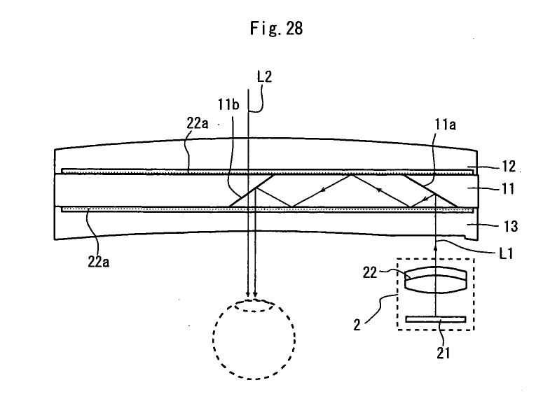

The third representative embodiment is shown in FIG. 28, which is directed to an eyeglass display. Below, only differences from the first representative embodiment are mainly described. FIG. 28 is a schematic sectional view of the optical-system portion of the eyeglass display, taken along the horizontal plane of the viewer. The eyeglass display is structured such that, in contrast to the eyeglass display of the first representative embodiment (see FIG. 2), reinforcing reflective films 22a are used instead of the substituted films 12a, 13a. Each of the reinforcing reflective films 22a has the same function as in the second representative embodiment. That is, the lower limit of a range of incidence angle of visible light, for which the reinforcing reflective film 22a exhibits reflectance, is lower than the critical angle θ_{c} of a plane substrate 11. Hence, the eyeglass display can provide diopter correction similarly to the first representative embodiment. The eyeglass display also can achieve widening of the angle of view, similarly to the second representative embodiment.

The method of manufacturing the reinforcing reflective film in the case where the film is made of a HOE is the same as the method described in the first representative embodiment (see FIG. 4). However, the value of the angle θ in the optical system of FIG. 4 (the incidence angle of the laser beam that is incident on the hologram photosensitive material 35) is set to fall within the range of incidence angle of light for which the reinforcing reflective film 22a should exhibit reflectivity. The incidence angle and wavelength of light for which the reinforcing reflective film 22a should exhibit reflectivity are not of one kind. Hence, the photosensitive material 35 is subjected to multiple exposures while the angle θ and the wavelength of the laser beam are varied as required.

### EXAMPLE 7

This example is directed to a dielectric optical multilayer film that is suitable for use as the reinforcing reflective film 22a of the eyeglass display of the third representative embodiment. In this example, it is premised that the light source of the liquid-crystal display element 21 of the eyeglass display is polarized. In this example, automatic synthesis of the film structure using a computer was applied.

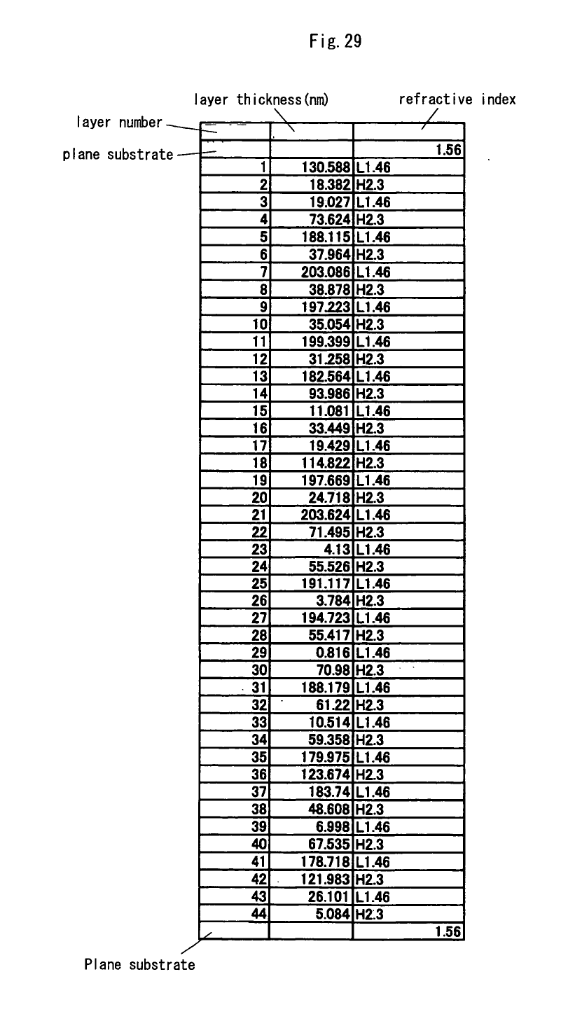

The film structure of the dielectric optical multilayer film of this example is shown in FIG. 29, in which the total number of layers is 44, the refractive index of the plane substrate 11 is 1.56, the refractive index of the high-refractive-index layers is 2.3, and the refractive index of the low-refractive-index layers is 1.46. The plane substrates and the low-refractive-index layers are the same as those of Example, and TiO₂, Ta₂O₅, or Nb₂O₅ was used to form the high-refractive-index layers H under an adjusted film-deposition condition.

FIG. 30 is a plot of wavelength characteristics of reflectance of the dielectric optical multilayer film of this example for light at small incidence angles (incidence angles in the range of 0° to 20°). In FIG. 30, Ra (0°), Ra (10°), and Ra (20°) are respective reflectances for light at incidence angles of 0°, 10°, and 20°, respectively (each being an average value of reflectance for the s-polarized component of the incident light and reflectance for the p-polarized component of the incident light). As apparent in FIG. 30, the dielectric optical multilayer film of this example exhibits a transmittance of 70% or higher for incident light in substantially the entire visible spectrum if the incidence angles are within 0° to 20°.

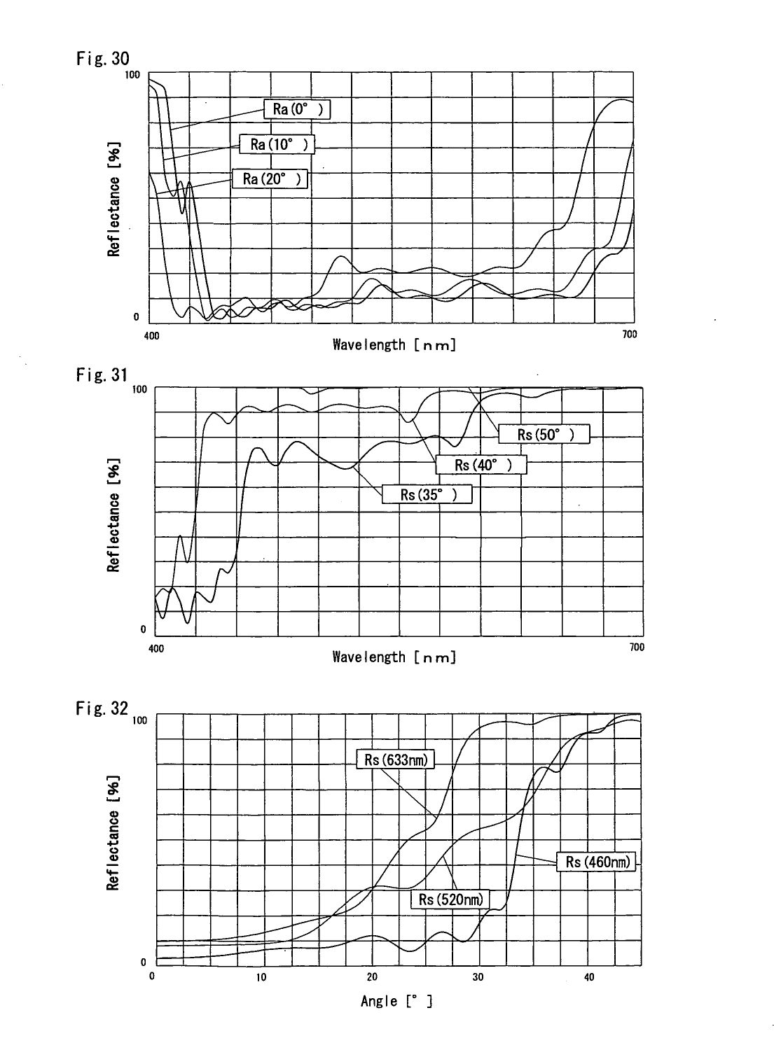

FIG. 31 is a plot of wavelength characteristics of reflectance of the dielectric optical multilayer film of this example for light at large incidence angles (incidence angles of 35° to 50°). In FIG. 31, Rs (35°), Rs (4020 ), and Rs (50°) are respective reflectances for light at incidence angles of 35°, 40°, and 50° (each being a reflectance for the s-polarized component of the incident light).

As apparent from FIG. 31, the dielectric optical multilayer film of this example exhibits a reflectance of 65% or higher for light in substantially the entire visible spectrum, if the incidence angles are 35° to 50°.

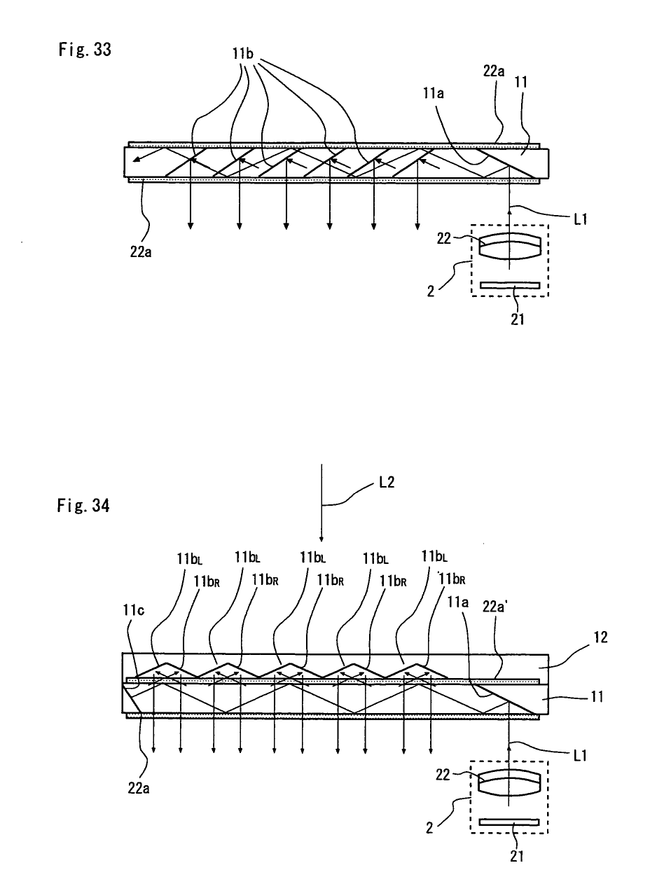

FIG. 32 provides plots of angle characteristics of reflectance of the dielectric optical multilayer film of this example for light having respective wavelengths. In FIG. 32, Rs (633 nm), Rs (520 nm), and Rs (460 nm) are reflectances for lights (R color, G color, and B color) having wavelengths of 633 nm, 520 nm, and 460 nm, respectively (each being a reflectance for the s-polarized component of the incident light). As apparent from FIG. 32, the dielectric optical multilayer film of this example exhibits a reflectance of 65% or higher for light of the respective components of R color, G color, and B color in the visible spectrum, if the incidence angles are 35° or greater. That is, 35° is a lower limit of incidence angle range of visible light (here, s-polarized light having wavelengths of 633 nm, 520 nm, and 460 nm) for which the dielectric optical multilayer film of this example exhibits reflectance. This angle is smaller than the critical angle θ_{c}=39.9° of the plane substrate 11 (refractive index 1.56) assumed in this example.

Hence, in the eyeglass display using the dielectric optical multilayer film of this example as the reinforcing reflective film 22a, the lower limit of the range of incidence angle θ_{g} of the image-carrying light flux 11 that is internally reflected in the plane substrate 11 is lowered from the critical angle θ_{c}=39.9° to 35° by as much as 4.9°. As shown in FIG. 30, the dielectric optical multilayer film of this example has high transmittance for visible light at a small incidence angle (0° to 20°). As a result, visibility of objects outside the eyeglass display is ensured, and there is no loss of the image-carrying light flux L1 that is incident on the exit pupil from the plane substrate 11.

### Fourth Representative Embodiment

This embodiment is described with reference to FIG. 33. In this embodiment, the reinforcing reflective film is applied to an eyeglass display having a large exit pupil. FIG. 33 is a schematic sectional view of the optical-system portion of the eyeglass display, taken along a horizontal plane of the viewer. The eyeglass display has multiple half-mirrors 11b that are parallel to one another. These half-mirrors are provided in a plane substrate 11 in which an image-carrying light flux L1 is internally reflected. Each of the half mirrors 11b reflects light that is incident at an angle within a predetermined range of incidence angle for the image-carrying light flux L1 internally reflected in the plane substrate 11. An exit pupil is formed outside the plane substrate 11. The size of the exit pupil is increased accordingly as a result of using the multiple half mirrors 11b. The large exit pupil is advantageous in terms of enhancing the degree of freedom of the position of the pupil of the viewing eye.

In this eyeglass display, reinforcing reflective films 22a are formed on the viewer-side surface and on the external-side surface, respectively, of the plane substrate 11 so as to be in close contact therewith. As in the other embodiments described above, the reinforcing reflective films 22a widen the range of incidence angle, thereby allowing the image-carrying light flux L1 to be internally reflected in the plane substrate 11. As a result, the angle of view of this eyeglass display is also widened.

### Fifth Representative Embodiment

This embodiment is shown in FIG. 34. In this embodiment the reinforcing reflective film is used to provide an eyeglass display having a large exit pupil. FIG. 34 is a schematic sectional view of the optical-system portion of the eyeglass display of this embodiment, taken along the horizontal plane of the viewer. As shown in FIG. 34, in the eyeglass display a plurality of half-mirrors are provided outside the plane substrate 11 for forming a large exit pupil. The plural half-mirrors are provided in a plane substrate 12 that is disposed on an external side or on a viewer side (external side in FIG. 34). The plural half-mirrors are of two kinds, namely, half-mirrors 11b_{L} that are parallel to one another and half-mirrors 11b_{R} that are parallel to one another but different in posture from the half-mirrors 11b_{L}.

Inside the plane substrate 11 are: a guide mirror 11a for polarizing the image-carrying light flux L1 that is incident on the plane substrate 11 at an angle allowing the image-carrying light flux L1 to be internally reflected; and a return mirror 11c that turns back the image-carrying light flux 11 that has been internally reflected in the plane substrate 11. By operation of the return mirror 11c, the image-carrying light flux L1 of the eyeglass display reciprocates while being internally reflected in the plane substrate 11. The posture of the half-mirrors 11b_{L} is set so that the image-carrying light flux L1 on the forward route is polarized toward the viewer side. The posture of the other half-mirrors 11b_{R} is set so that the image-carrying light flux L1 on the return route is polarized toward the viewer side. Hence, the entire structure of the half mirrors 11b_{L}, 11b_{R} is one in which roof-shaped half mirrors are arranged close to one another.

In this eyeglass display, the reinforcing reflective films are situated between the plane substrate 12 and the plane substrate 11 and in close contact with the surface of the plane substrate 11 on the viewer side. The reinforcing reflective film 22a on the viewer side of the plane substrate 11 is the same as in the embodiments described above, and exhibits reflectance for the image-carrying light flux L1 that is internally reflected in the plane substrate 11.

On the other hand, the reinforcing reflective film 22a′ on the external side of the plane substrate 11 is slightly different from corresponding films in the foregoing embodiments, and exhibits a semi-transmittance for the image-carrying light flux L1 that is internally reflected in the plane substrate 11. Specifically, the reinforcing reflective film 22a′ exhibits a transmittance (total transmittance) for the image-carrying light flux L1 that should pass through the plane substrate 11 and the external light flux L2 (here, visible light incident at an approximately 0° angle of incidence). The reinforcing reflective film 22a′ also exhibits a semi-transmittance for the image-carrying light flux L1 that should be internally reflected in the plane substrate 11 (here, visible light that is incident at an approximately 60° angle of incidence). The lower limit of the range of angle of incidence of the light for which it exhibits semi-transmittance is smaller than the critical angle θ_{c} of the plane substrate 11.

As a result of the semi-transmittance of the reinforcing reflective film 22a′, a certain proportion of the image-carrying light flux L1 reciprocating in the plane substrate 11 propagates toward the plane-substrate 12 side. The propagating image-carrying light flux L1 is polarized by the half-mirrors 11b_{L}, 11b _{R} in the plane substrate 12 toward the viewer side. The image-carrying light flux L1 polarized by the half-mirrors 11b_{L}, 11b_{R} passes through the reinforcing reflective film 22a′, the plane substrate 11, and the reinforcing reflective film 22a to form a large exit pupil.

The reinforcing reflective films 22a, 22a′ described above widen the range of angle of incidence allowing the image-carrying light flux L1 to be internally reflected, similarly to those of the above-described embodiments. Accordingly, the angle of view of the eyeglass display is also widened.

In the eyeglass display, the return mirror 11cand two kinds of half-mirrors are provided, but it should be noted that the return mirror 11c and the half-mirrors 11b_{R} can be omitted. However, providing these mirrors makes uniform the light intensity in the exit pupil and thus is preferred.

### Sixth Representative Embodiment

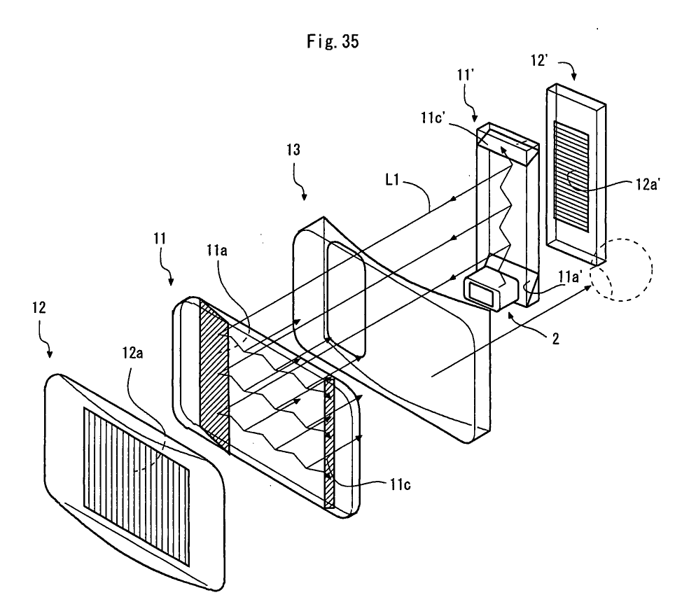

In this embodiment the reinforcing reflective film is applied to an eyeglass display with a still larger exit pupil. FIG. 35 is an exploded view of the optical-system portion of the eyeglass display of this embodiment. As shown in FIG. 35, the same principle as applied to the eyeglass display of the fifth representative embodiment is applied to the instant eyeglass display. The exit pupil is expanded in two directions (vertical and horizontal) when viewed from the viewer. This eyeglass display also provides diopter correction of the viewing eye.

In FIG. 35 the image-carrying light flux L1 radiated from the image-introduction unit 2 is first incident on a plane substrate 11′. The plane substrate 11′, together with a plane substrate 12′, guides the image-carrying light flux L1 and expands the diameter of the image-carrying light flux L1 in the vertical direction when viewed from the viewer. The image-carrying light flux L1 is incident on the plane substrate 11. The plane substrate 11, together with the plane substrate 12, guides the image-carrying light flux L1 to expand the diameter of the image-carrying light flux L1 in the horizontal direction when viewed from the viewing eye. A plane substrate 13 is also provided on the viewer side of the plane substrate 11. The respective optical powers of the viewing-eye-side surface of the plane substrate 13 and the external-side surface of the plane substrate 12 achieve diopter correction of the viewing eye for an external field.

The same principle as applied to the plane substrates 11, 12 of the fifth representative embodiment is applied to the first optical system (comprising the plane substrates 11′, 12′) and the second optical system (comprising the plane substrates 11, 12). The arrangement direction of optical surfaces of the first optical system is rotated 90° from the arrangement direction of optical surfaces of the second optical system. Specifically, in the plane substrate 11′, the reference symbol 11a′ denotes a guide mirror that polarizes the image-carrying light flux L1 that is incident on the plane substrate 11′ to an angle that allows the image-carrying light flux L1 to be internally reflected. The reference numeral 11c′ denotes a mirror that returns the image-carrying light flux L1 that has been internally reflected in the plane substrate 11′. In the plane substrate 12′, the reference symbol 12a′ denotes a plurality of roof-shaped half-mirrors arranged close to one another (for details, see FIG. 34).

In the plane substrate 11, the reference numeral 11a denotes a guide mirror that polarizes the image-carrying light flux L1 that is incident on the plane substrate 11 to an angle that allows the image-carrying light flux L1 to be internally reflected. The reference numeral 11c denotes a mirror that return the image-carrying light flux L1 that has been internally reflected in the plane substrate 11. In the plane substrate 12 the reference numeral 12a denotes a plurality of roof-shaped half-mirrors that are arranged close to one another (for details, see FIG. 34).

In this eyeglass display, respective reinforcing reflective films are provided between the plane substrate 11′ and the plane substrate 12′, between the plane substrate 11′ and the plane substrate 13′, between the plane substrate 11 and the plane substrate 12, and between the plane substrate 11 and the plane substrate 13. However, the reinforcing reflective film provided between the plane substrate 11′ and the plane substrate 12′ must allow a certain proportion of the image-carrying light flux L1, which is internally reflected in the plane substrate 11′, to propagate through the film to the plane substrate 12′. This characteristic is identical to the characteristic of the reinforcing reflective film 22a′ of the fifth representative embodiment. The reinforcing reflective film provided between the plane substrate 11 and the plane substrate 12 also must allow a certain proportion of the image-carrying light flux L1, which is internally reflected in the plane substrate 11, to propagate through the film to the plane substrate 12. This characteristic is identical to the characteristic of the reinforcing reflective film 22a′ of the fifth representative embodiment.

These reinforcing reflective films widen the range of angle of incidence that allows the image-carrying light flux L1 to be internally reflected in the plane substrate 11′. The films also widen the range of angle of incidence that allows the image-carrying light flux L1 to be internally reflected in the plane substrate 11. Moreover, the widening direction in the plane substrate 11′ and the widening direction in the plane substrate 11 are 90° different from each other. As a result, in this eyeglass display, the angle of view in the vertical direction and the angle of view in the horizontal direction are both widened.

### Seventh Representative Embodiment

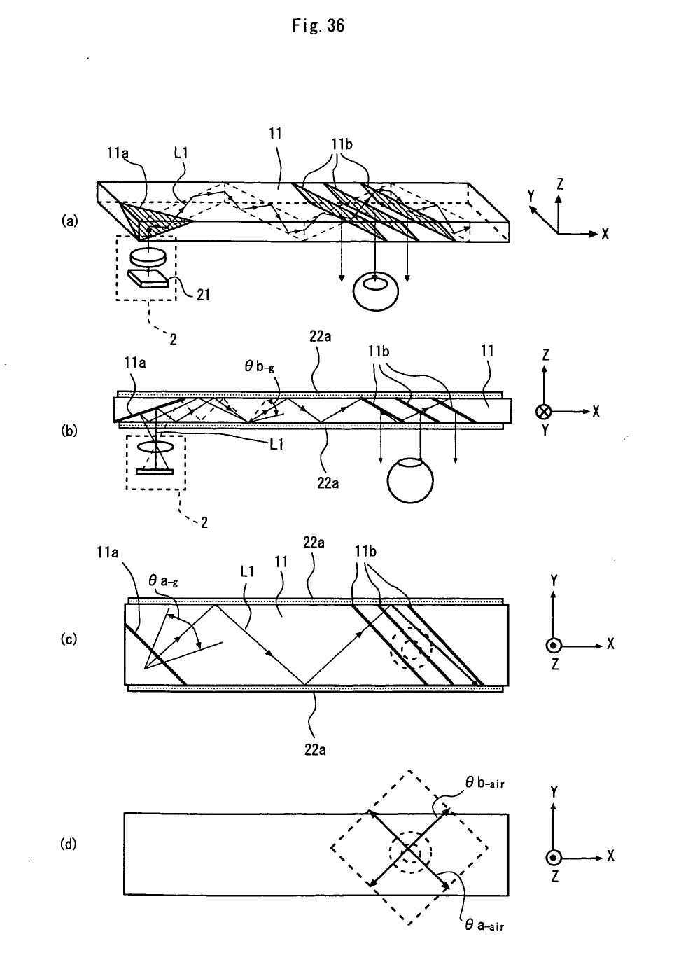

In this embodiment, the reinforcing reflective film is applied to an eyeglass display in which many surfaces are used for internal reflection. FIG. 36(a) is a schematic perspective view of the optical-system portion of the eyeglass display. FIG. 36(b) is a schematic sectional view of the optical-system portion along the horizontal plane (the ZX plane in FIG. 36(a)) of a viewer. FIG. 36(c) is a schematic sectional view of the optical-system portion along a plane in front of the viewer (the YX plane in FIG. 36(a)). FIG. 36(d) is a diagram used for explaining the angle of view of the eyeglass display. As shown in FIGS. 36(a)-36(c), by adjusting the arrangement locations and postures of the guide mirror 11a and the half-mirrors 11b, a total of four surfaces in the plane substrate 11 are used for internal reflection. The four surfaces are the viewer-side surface, the external-side surface, and two surfaces sandwiched by these surfaces. These four surfaces are all planar surfaces.

FIG. 36(d) shows angles of view θb₋ₐᵢᵣ, °a₋ₐᵢᵣ in two directions of the image produced by the eyeglass display when viewed from the viewing eye. Of these angles, the angle of view θb₋ₐᵢᵣ is determined by an angle range θb_{-g} that allows the image-carrying light flux L1 to be internally reflected on the two surfaces (namely, the viewer-side surface and the external-side surface of the plane substrate 11), as shown in FIG. 36(b). The angle of view θa₋ₐᵢᵣ is determined by an angle range θa_{-g} that allows the image-carrying light flux L1 to be internally reflected on the other two surfaces of the plane substrate 11, as shown in FIG. 36(c). These are expressed by the following: I.e., the angles of view θa₋ₐᵢᵣ, θb₋ₐᵢᵣ become larger as the angle ranges θa_{-g}, θb_{-g} allowing the image-carrying light flux L1 to be internally reflected in the plane substrate 11 are increased.

The reinforcing reflective films are provided on the four surfaces of the plane substrate 11 used for internal reflection. In FIGS. 36(b) and 36(c), the reference symbol 22a denotes the reinforcing reflective films. The reinforcing reflective film 22a has the same characteristic as the reinforcing reflective films 22a in the above-described embodiments. The lower limit of the range of incidence angle of visible light for which the reinforcing reflective film 22a is reflective is lower than the critical angle θ of the plane substrate 11. Consequently, the angle ranges θb_{-g}, θa_{-g} (FIGS. 36(b)-36(c)) allowing the image-carrying light flux L1 to be internally reflected in the plane substrate 11 are widened. The angles of view θa₋ₐᵢᵣ, θb₋ₐᵢᵣ (FIG. 36(d)) of the eyeglass display are also widened.

The two reinforcing reflective films 22a shown in FIG. 36(c) do not face the viewing eye, and hence need not transmit the external light flux. Hence, it is desirable that a metal film of silver, aluminum, or the like be used as each of these two reinforcing reflective films 22a instead of a dielectric optical multilayer film or HOE. Use of a metal film can make the angle of view θa₋ₐᵢᵣ still larger than the angle of view θb₋ₐᵢᵣ. If the aspect ratio of the liquid-crystal display element 21 is not 1:1, then the liquid-crystal display element 21 desirably is disposed so that the angle of view of the longer side corresponds to the angle of view θa₋ₐᵢᵣ.

The plane substrate 11 of the eyeglass display is a columnar substrate having a rectangular cross-section. Alternatively usable is a columnar substrate having a differently shaped cross-section such as a columnar substrate having a triangular cross-section, a columnar substrate having a parallelogram cross-section, or a columnar substrate having a pentagonal cross-section.

### Eighth Representative Embodiment

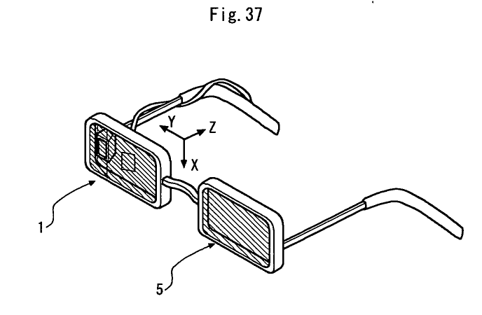

This embodiment, directed to an eyeglass display, is depicted in FIGS. 37-42. Only differences from the first representative embodiment are mainly described below.

FIG. 37 is an external view of the eyeglass display. The coordinate system in FIG. 37 is a right-handed XYZ Cartesian coordinate system in which the X-direction points downward and the Y-direction points rightward if viewed from a viewer wearing the eyeglass on his head. In the following description, the direction expressed by the XYZ coordinate system or the direction expressed by left, right, up, and down viewed from the viewer will be used as required. In FIG. 37 the image-display optical system 1 of the eyeglass display has a light-reducing function, namely reducing the external light flux directed from an external field toward the viewing eye (right eye of the viewer). To balance light intensity of the external light flux directed from the external field toward the viewing eye and the light intensity of the external light flux directed from the external field toward the non-viewing eye (left eye of the viewer), and also to balance right and left external appearances of the eyeglass display, the non-viewing eye-side front also has a light-reducing function similar to that of the image-display optical system 1. Also, a plane substrate 5 having the same external appearance as the image-display optical system 1 is attached to the non-viewing eye-side front. This does not apply to a case in which there is no need to balance the external light fluxes and balance the external appearances.

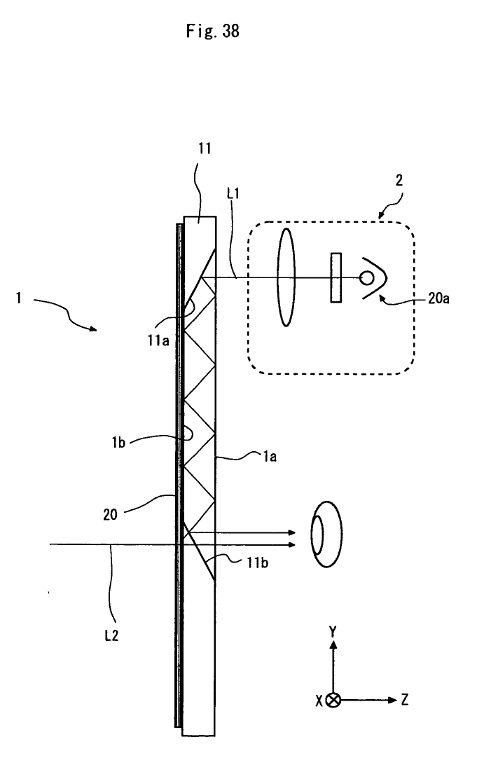

FIG. 38 is a detailed view of the optical system of the eyeglass display. Also provided is a schematic sectional view of the optical-system portion of the eyeglass display taken along a plane parallel to the YZ plane. The reference numeral 20a denotes an illumination-optical system including an LED light source, a mirror, etc., which are not shown in the drawing of the first representative embodiment. The image-display optical system 1 includes one plane substrate 11 exhibiting transmittance at least to visible light. At specified positions in the plane substrate 11, a guide mirror 11a and a half-mirror 11b, similar to those of the first representative embodiment, are provided in predetermined locations. As in the first representative embodiment, a possible alternative for the half-mirror 11b is a polarizing optical film, such as a polarizing beam-splitter or a holographic optical film, that is transparent to an external light flux L2 consisting of visible light.

On the external-side surface 1b of the plane substrate 11, a light-reducing film 20 is provided that reduces the external light flux L2 by a predetermined reduction ratio. The function of the light-reducing film 20 is to reduce, by the ratio, the brightness of the external image. A concrete example of the light-reducing film 20 is as follows: A material for a general light-reducing film is a metal element such as aluminum (Al), chrome (Cr), tungsten (W), or rhodium (Ro), or an alloy of Inconel or the like. However, these materials have a light-absorbing property (absorbency). Hence, if no consideration were given in providing the light-reducing films 20 on the surface of the plane substrate 11, a certain amount of an image-carrying light flux L1, which is internally reflected in the plane substrate 11, would be absorbed by the light-reducing film 20. That is, the light intensity in the light path of the image-carrying light flux L1 is greatly lost. To prevent loss of light intensity, a two-layer film made of superposed silver (Ag) film and a dielectric film is used as the light-reducing film 20 in this embodiment. The basic structure of the light-reducing film 20 is as follows:

plane substrate/Ag/0.25L/air

where Ag is the silver (Ag) layer and L is the low-refractive-index dielectric (L layer). The numerical value on the left of the L layer is the optical-layer thickness of the L layer (for a center wavelength of the wavelength range that is used). In this basic structure, the L layer serves to protect the surface of the Ag layer that otherwise would be subject to deterioration in air. The L layer also improves the reflectance for incident light at a large incidence angle.

Details (specifications) of the light-reducing film 20 are as follows:
set transmittance: 30% (for 0-degree incidence angle)
center wavelength λc: 500 nm
refractive index of the plane substrate: 1.56
layer thickness of the Ag layer: 30 nm
refractive index of the L layer: 1.46

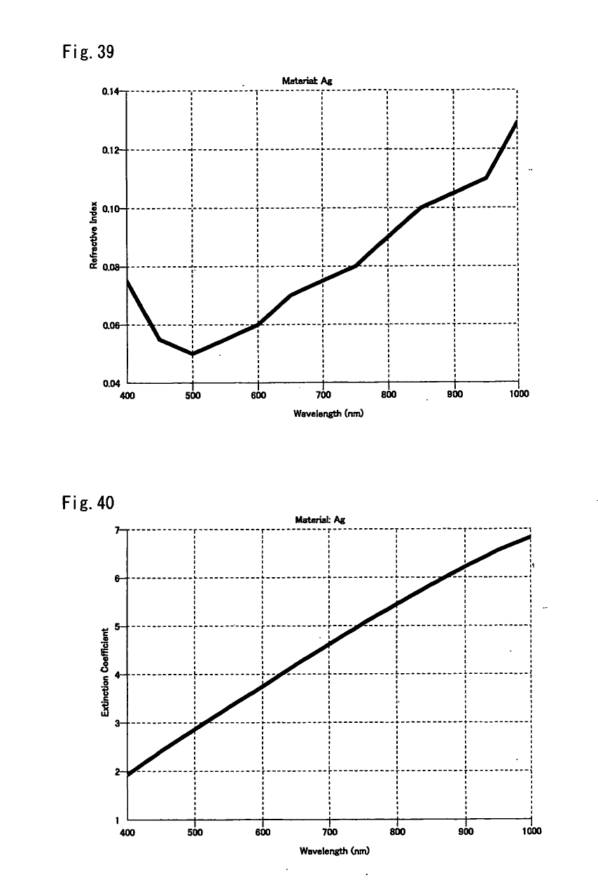

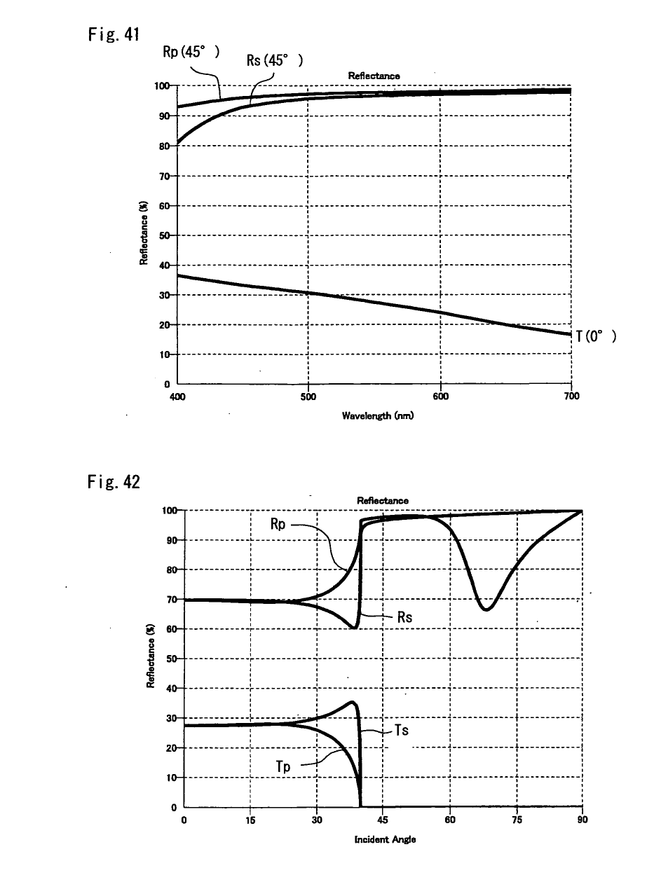

The optical constants (refractive index and extinction coefficient, as functions of wavelength) of the Ag layer as a single element are shown in FIGS. 39 and 40, respectively. The wavelength characteristics of reflectance and transmittance of the plane substrate 11 side of the light-reducing film 20 (incidence angles of 0° and 45°) are shown in FIG. 41. The angle characteristics of reflectance and transmittance of the plane substrate 11 side of the light-reducing film 20 (wavelength 550 nm) are shown in FIG. 42. In FIGS. 41 and 42, “R” denotes reflectance and “T” denotes transmittance. The suffix “p” on R and T denotes that the R or T value is for the p-polarized component, and the suffix “s” on R and T denotes that the R or T value is for the s-polarized component (the same applies to other drawings). As apparent from FIGS. 41 and 42, the light-reducing film 20 exhibits substantially 100% reflectance for visible light of the s-polarized component at an incidence angle of 40° or more, and the light-reducing film 20 exhibits about 30% transmittance for visible light at an incidence angle of 0°. Hence, the light-reducing film 20 reduces attenuation of light intensity in the optical path of the image-carrying light flux L1 and reduces only the external light flux L2 in the visible spectrum at a reduction ratio of about 70%.

The brightness of an image (display image) viewed by the viewing eye is maintained, and brightness of the external image is reduced to about 30%. Consequently, visibility of the display image when the external field is bright is surely enhanced. Selecting a suitable kind of film, based on the reflectance-transmittance characteristics of the light-reducing film 20 as functions of incidence angle, provides the desired effect with minimum structure.

Although the basic structure of the light-reducing film 20 of this embodiment is a two-layer structure comprising an Ag layer and a dielectric layer, another metal layer may be used instead of the Ag layer. Alternatively, a three-layer structure, in which two dielectric layers sandwich a metal layer, may be used. The two-layer structure (Ag layer and dielectric layer) can more easily provide good operational characteristics, notably reducing only the external light flux L2 without increasing the attenuation of intensity of the image-carrying light flux L1.

### First Modification Example of the Eighth Representative Embodiment

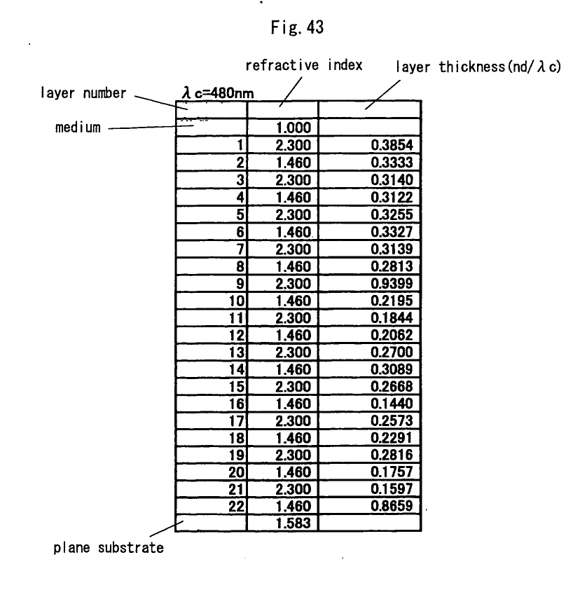

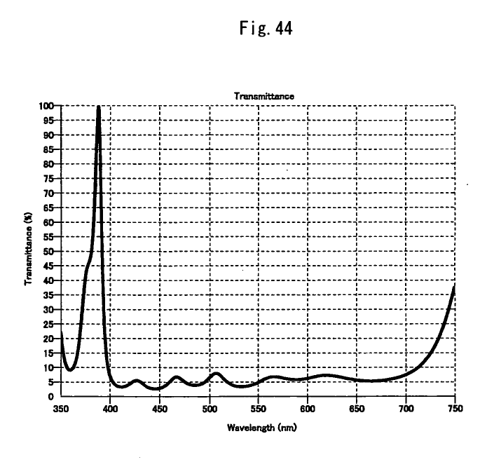

This example is shown in FIGS. 43 and 44, and is directed to a modification of the light-reducing film 20. The light-reducing film 20 of this example is made only of a dielectric. The thickness of each layer is set so that phases of reflected light on interfaces of the respective layers have a desired relation. Depending on the relation of the phases of reflected light, various characteristics can be established. Hence the degree of freedom with which transmittance is set is higher than of the light-reducing film 20 of the eighth representative embodiment. There are three kinds of basic structures of this light-reducing film 20, as follows:

plane substrate/(0.25H0.25L)^{p}0.25H/air

plane substrate/(0.125H0.25L0.125H)^{p}/air

plane substrate/(0.125L0.25H0.125L)^{p}/air

where H denotes a high-refractive index dielectric (H layer), L denotes a low-refractive index dielectric (L layer), the numerical value on the left of each layer is the respective optical-layer thickness (for the center wavelength of the wavelength range used), and p denotes the number of stacks of a parenthesized layer group. According to these basic structures, it is possible to reduce transmittance for specific light as well as improve reflectance for specific light.

However, to ensure attenuation of brightness of an external image, it is necessary, in configuring the light-reducing film 20, to arrange multiple kinds of layer-group cycles that are different in center wavelength so as to widen the wavelength range of light for which transmittance can be reduced, up to the entire visible spectrum. To reduce variation in transmittance as a function of light, the layer thickness should be optimized for all the layers using a computer.

Details (specifications) of the light-reducing film 20 after optimization are as follows:
set transmittance: 5%
center wavelength λc: 480 nm
refractive index of the plane substrate: 1.583
refractive index of the H layers: 2.3
refractive index of the L layers: 1.46
total number of layers: 22
   The structure of the light-reducing film 20 is shown in FIG. 43. As the plane substrate, N-BAF3 manufactured by SCHOTT was used, and the same H layers and L layers as in Example 6 were used.

The wavelength characteristic of transmittance of the light-reducing film 20 is shown in FIG. 44. As is apparent from this figure, the light-reducing film 20 exhibits about 5% transmittance for visible light. Hence, according to this example, the brightness of the external image is reduced to about 5%.

### Second Modification Example of the Eighth Representative Embodiment

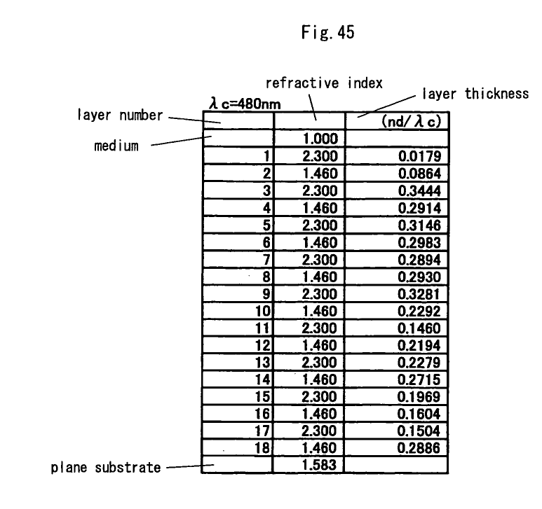

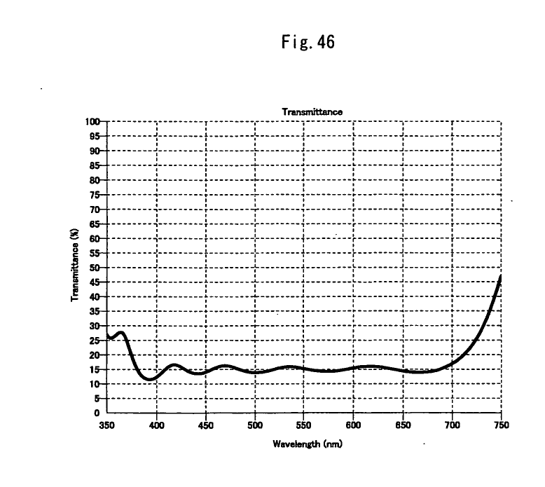

This example is shown in FIGS. 45 and 46. This modification example is directed to a modification of the light-reducing film 20. The set transmittance of the light-reducing film 20 of this example is 15%. This light-reducing film 20 is also made only of a dielectric. Its basic structure is the same as that of the first modification example.

Details (specifications) of the light-reducing film 20 are as follows:
set transmittance: 15%
center wavelength λc: 480 nm
refractive index of the plane substrate: 1.583
refractive index of the H layers: 2.3
refractive index of the L layers: 1.46
total number of layers: 18
   The structure of this light-reducing film 20 is shown in FIG. 45. The same materials as in the first modification example of this embodiment are used.

The wavelength characteristic of transmittance of this light-reducing film 20 is shown in FIG. 46, which shows that the light-reducing film 20 exhibits about 15% transmittance for visible light. Hence, in this example, the brightness of the external image is attenuated to about 15%.

### Supplement to Modification Example

In view of the conditions of the inner-surface reflection of the plane substrate 11, the following discussion addresses the condition under which the light-reducing films 20 of the first modification example and of the second modification example ensure brightness of the display image. That is, the discussion addresses the condition under which about 100% reflectance is achieved for the image-carrying light flux L1 that is internally reflected in the plane substrate.

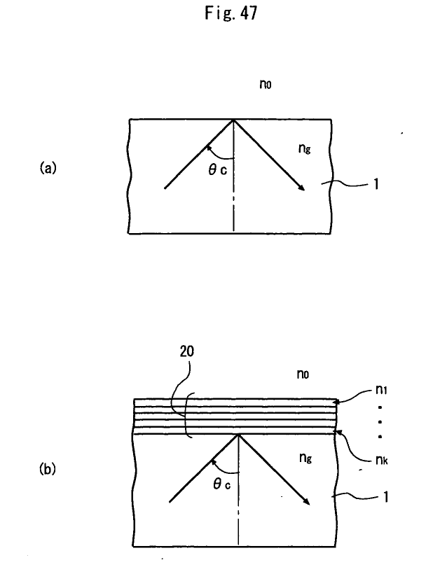

First, suppose a state with no light-reducing film 20 provided on the plane substrate 11, as shown in FIG. 47(a). The following expression holds according to Snell's law, where n₀ is the refractive index of air (in which medium the plane substrate 11 exists), n_{g} is the refractive index of glass (being the material of the plane substrate 11), and θ₀ and θ_{g} are the respective angles of incidence of light on the plane substrate 11 and the medium:
n₀ sin θ₀=n_{g} sin θ_{g}
Hence, the critical angle θ_{c} (the minimum value of the incidence angle that allows light to be internally reflected) of the plane substrate 11 in this state is expressed as:
θ_{c}=arc sin(n₀/n_{g})

Next, suppose a state in which the light-reducing film 20, made of a dielectric multilayer film, is provided on the plane substrate 11, as shown in FIG. 47(b). If each layer of the multilayer film has no absorbency (zero absorbency), the following expression holds according to Snell's law, where n₁, n₂, . . . , nₖ are refractive indices of the respective layers of the multilayer film, and θ₁, θ₂, . . . , θₖ, are incidence angles of light on the respective layers:
n₀ sin θ₀=n₁ sin θ₁
=n₂ sin θ₂
. . .
=nₖ sin θₖ
=n_{g} sin θ_{g}
If each layer of the multilayer film has no absorbency, the critical angle θc of the plane substrate 11 is expressed by the same expression as used for the state in which no light-reducing film 20 is provided. Hence, a non-absorbent dielectric is used to form the light-reducing films 20 of the first modification example and of the second modification example.

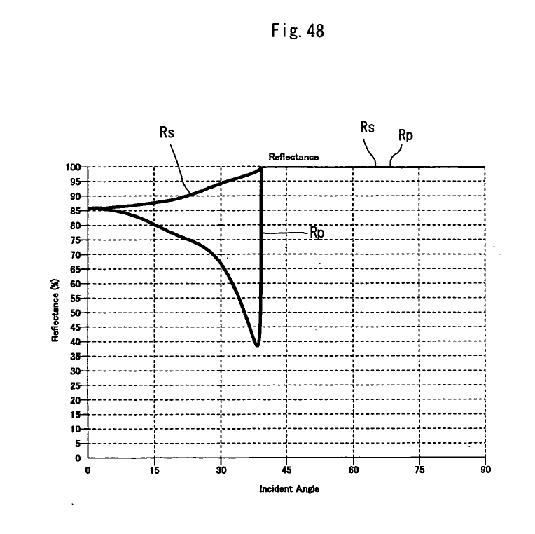

The angle characteristics of reflectance of the plane-substrate 11 side of the light-reducing films 20 (reflectance of the internal reflection of the plane substrate 11) of the first modification example and the second modification example using the non-absorbent dielectric are shown in FIG. 48, which shows that the light-reducing film 20 exhibits about 100% reflectance for light at an incidence angle of 45% or more.

### Third Modification Example of Eighth Embodiment

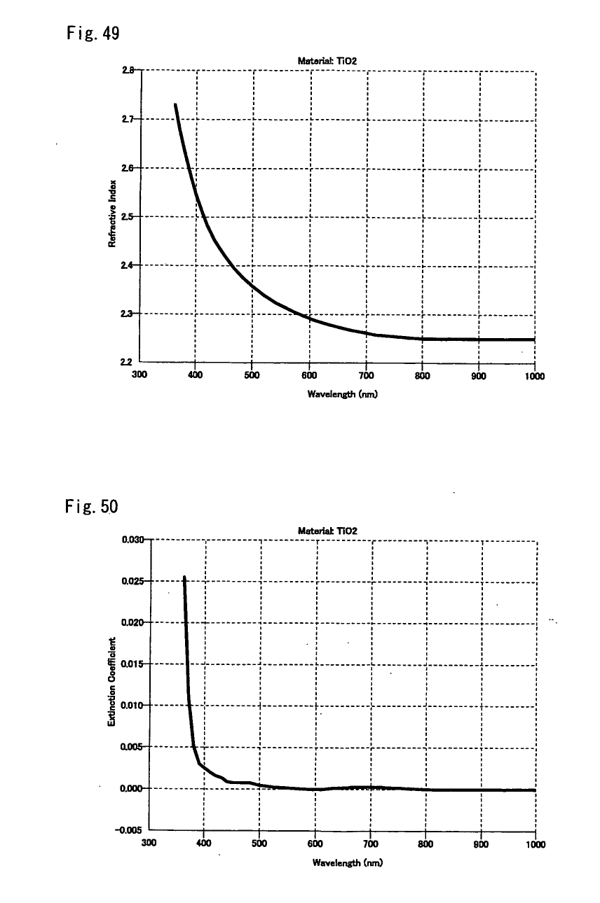

This example is shown in FIGS. 49-53, and is directed to a modification of the light-reducing film 20. The light-reducing film 20 of this example has the functions of ultraviolet and infrared protection. The light-reducing film 20 is made only of a dielectric. Its basic structure is similar to that of the first modification example and the second modification example.

To provide ultraviolet and infrared protection, an absorbent dielectric is positively used as the H layers. As the absorbent dielectric, titanium dioxide (TiO₂) is used. Optical constants of titanium dioxide (TiO₂) are shown in FIGS. 49 and 50, in which FIG. 49 shows the wavelength characteristic of refractive index of titanium dioxide (TiO₂), and FIG. 50 shows the wavelength characteristic of the extinction coefficient of titanium dioxide (TiO₂).

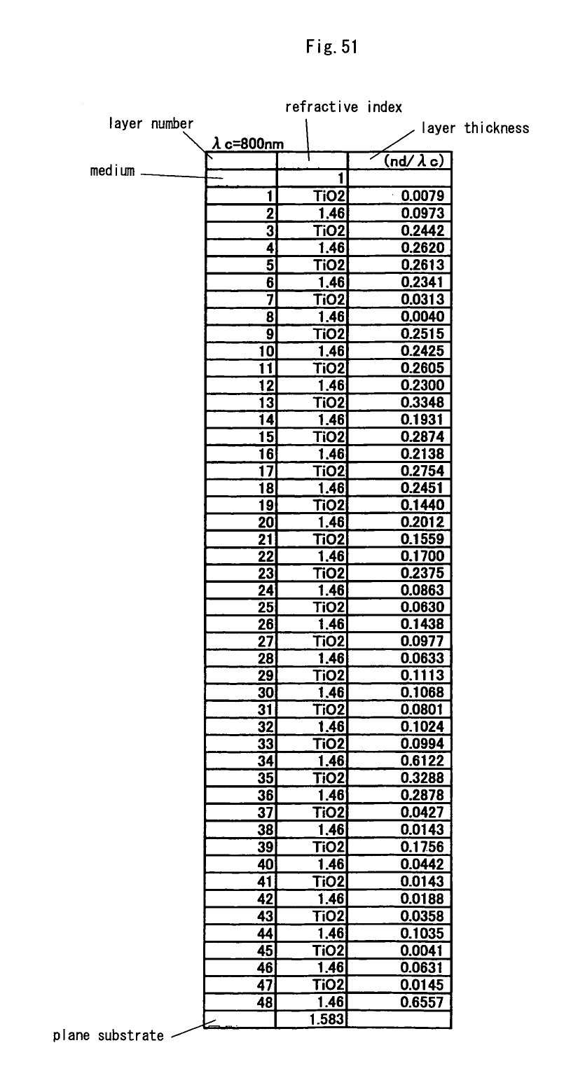

Details (specifications) of this light-reducing film 20 are as follows:
set transmittance: 30%
center wavelength λc: 800 nm
refractive index of the plane substrate: 1.583
refractive index of the L layers: 1.46
total number of layers: 48
   The structure of the light-reducing film 20 is shown in FIG. 51. The same respective materials as those of the first modification example of this embodiment were used for the plane substrate and the L layers.

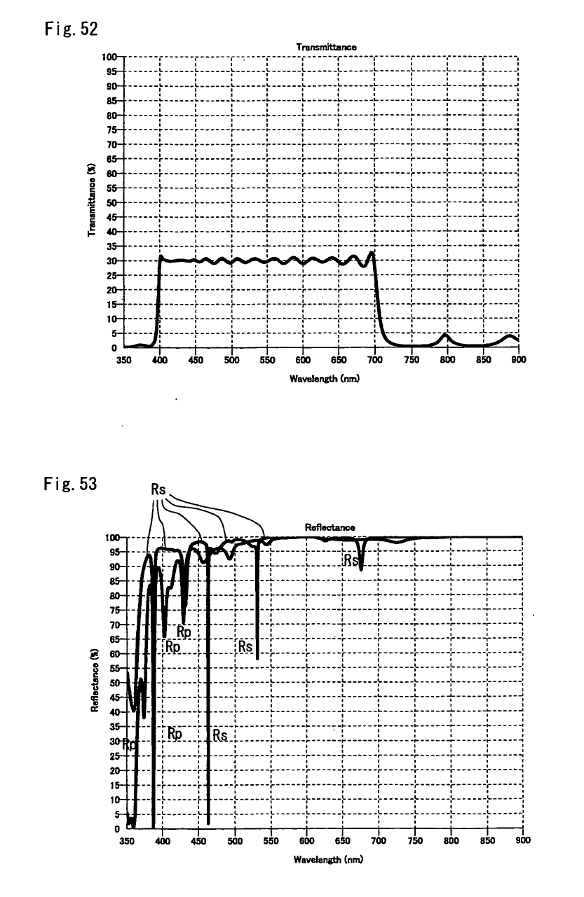

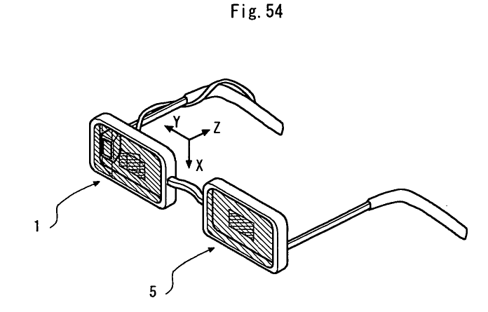

The wavelength characteristic of transmittance of the light-reducing film 20 is shown in FIG. 52. The wavelength characteristics of reflectance of the plane substrate 11 side of the light-reducing film 20 (i.e., reflectance of the internal reflection of the plane substrate 11) of this modification example are shown in FIG. 53. In FIG. 53, the wavelength curves have indentations (valleys of reflectance). On the other hand, the emission profile of the liquid-crystal display element 21 of the eyeglass display generally has peaks in the respective wavelengths of R color, G color, and B color. Hence the structure of the light-reducing film 20 of this modification example is finely adjusted so that the valleys of the wavelength curve for reflectance are different from the peaks of the emission curve.

As a result, each wavelength component included in the image-carrying light flux L2 is surely internally reflected in the plane substrate 11 with high reflectance, which ensures the brightness of the display image.

As shown in FIG. 53, the curve for the s-polarized component and the curve for the p-polarized component are different in the locations of the valleys of the respective curves. In particular, the number of valleys appearing in the curve for the p-polarized component is less than in the curve for the s-polarized component. Hence, in a case in which the light-reducing film 20 is applied to the eyeglass display, by limiting the image-carrying light flux L1 to p-polarized components, it is certainly possible to displace the valleys in the reflectance curve from the peaks of the emission curve.

As a result of normal function of the liquid-crystal display element 21, the image-carrying light flux L1 is polarized. Hence, by optimizing the positional relation of the liquid-crystal display element 21 and the plane substrate 11 so that the polarization direction becomes a p-polarized direction relative to the light-reducing film 20, or by inserting a phase-plate on the subsequent stage of the liquid-crystal display element 21, it is possible to limit the image-carrying light flux L1 only to the p-polarized components.

### Ninth Representative Embodiment

This embodiment is shown in FIGS. 54-57, and is directed to an eyeglass display. Below, only differences from the eighth representative embodiment are described.

FIG. 54 is an external view of the eyeglass display. The coordinate system in the figure is a right-handed XYZ Cartesian coordinate system in which the X-direction points downward and the Y-direction points rightward if viewed from a viewer. In the description below, the direction expressed by the XYZ coordinate system or the direction expressed by left, right, up, and down, as viewed from the viewer, will be used as required. As shown in FIG. 54, this eyeglass display is different from the eighth representative embodiment in that the light-reduction ratio of the center area near the half mirror 11b in the image-display optical system 1 is higher than the light-reduction ratio of the peripheral area outside the center area in the image-display optical system 1.

To balance the intensity of an external light flux directed from an external field toward the viewing eye (viewer's right eye) and the intensity of the external light flux directed from the external field toward the non-viewing eye (viewer's left eye), and to balance the right and left external appearances of the eyeglass display, the front of the non-viewing eye side has a light-attenuation function that is similar to that of the image-display optical system 1. A plane substrate 5 having the same external appearance as of the image-display optical system 1 is attached to the front of the non-viewing eye side. This does not apply to a case where there is no need to balance the external light fluxes and balance the external appearances.

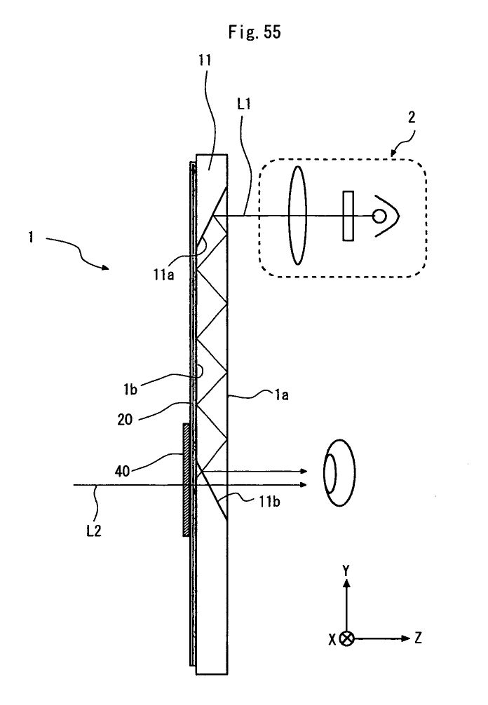

FIG. 55 is a detailed view of the optical system of the eyeglass display and is a schematic sectional view of the optical-system portion of the eyeglass display, along a plane parallel to the YZ plane. In FIG. 55 the behavior of the image-carrying light flux L1 and of the external light flux L2 in this eyeglass display are the same as those of in the eighth representative embodiment (see FIG. 38). On the external-side surface 1b of the plane substrate 11, the same light-reducing film 20 as in the eighth representative embodiment (or of its modification examples) is provided. However, in the center area of the surface of the light-reducing film 20, a light-reducing film 40 made of a multilayer film of metal or a dielectric is superposed. Consequently, the light-attenuation ratio of the center area of the image-display optical system 1 is higher than the light-attenuation ratio of the peripheral area of the image-display optical system 1.

The position of the center area viewed from the viewer and the position of the half-mirror 11b viewed from the viewer are substantially the same. Also, the size of the center area as viewed from the viewer is slightly larger than the size of the half-mirror 11b as viewed from the viewer.

In this eyeglass display the brightness of an external image of the background portion of the display image is especially attenuated, so that the visibility of the display image is further enhanced.

A concrete example of the light-reducing films 20, 40 is as follows. The light-reducing film 20 is made of the same dielectric multilayer film as in the modification examples of the eighth representative embodiment. The light-reducing film 40 is also made of the same dielectric multilayer film as in the modification examples of the eighth representative embodiment. The same plane substrate as in the modification examples of the eighth representative embodiment is also used. Details (specifications) of the light-reducing films 20, 40 are as follows:

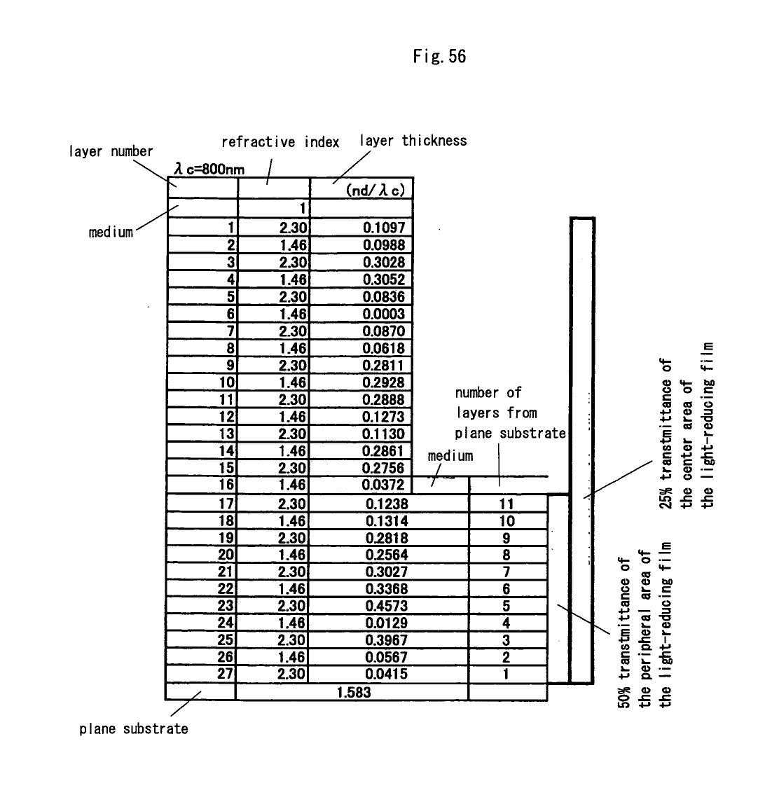

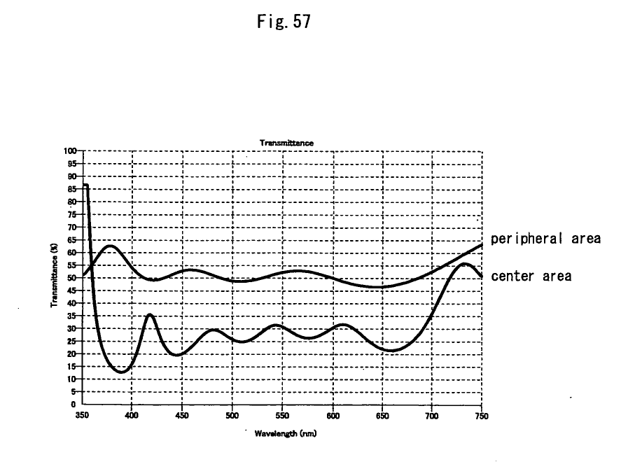

set transmittance of the light-reducing film 20: 50%
set transmittance of the light-reducing film 40: 50%
center wavelength λc: 800 nm
refractive index of the plane substrate: 1.583
refractive index of the H layers: 2.3
refractive index of the L layers: 1.46
total number of layers of the light-reducing film 20:11
total number of layers of the light-reducing film 40:16
   The structure of the light-reducing films 20, 40 is shown in FIG. 56. The wavelength characteristic of transmittance of the center area of the light-reducing films 20, 40 and the wavelength characteristic of transmittance of the peripheral area of the light-reducing film 20 are shown in FIG. 57. In FIG. 57, the transmittance of the center area for visible light is about 25% and the transmittance of the peripheral area for visible light is about 50%.

Therefore, in this eyeglass display, the brightness of the entire external image is reduced to about 50%, and the brightness of the external image in the background portion of the display image is reduced to about 25%.

In this embodiment the light-reducing film 20 and the light-reducing film 40 are superposed, but they need not be. In this case, the light-reducing film 20 (having an opening in the center area) is provided on the plane substrate 11, and the light-reducing film 40 (having a higher light-reduction ratio than the film 20) is provided in the opening. In this case, masking is required both during the formation of the light-reducing film 20 and during the formation of the light-reducing film 40. Hence, superposing the light-reducing film 20 and the light-reducing film 40 on each other is more desirable in terms of reducing manufacturing cost.

### First Modification Example of the Ninth Representative Embodiment

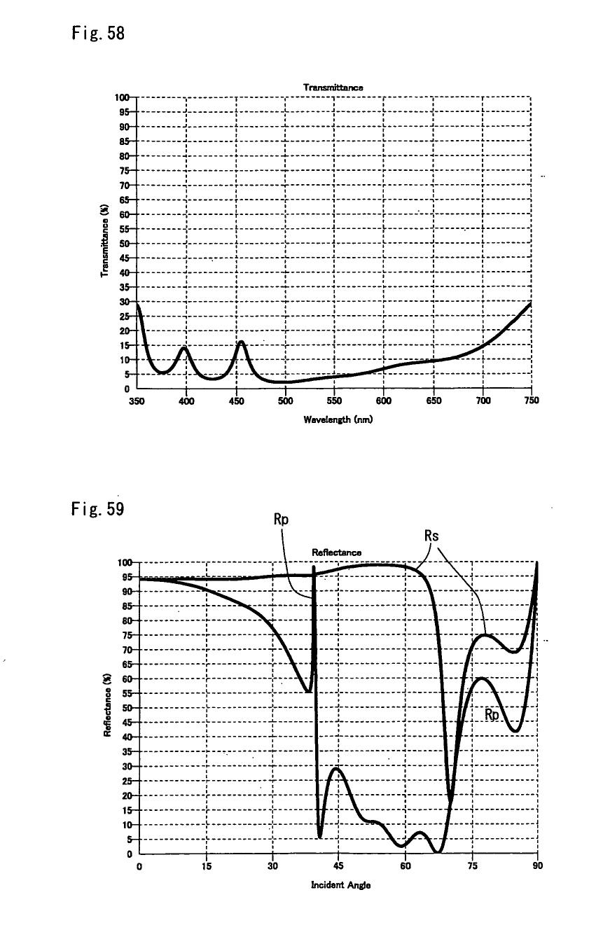

This example is shown in FIGS. 58 and 59, and is directed to the light-reducing film 20 and the light-reducing film 40. The light-reducing film 40 of this example is made of a metal film. The structure of the light-reducing film 20 of this example is as shown in FIG. 45. The light-reducing film 20 as a single element has the same characteristic as that shown in FIG. 46. The light-reducing film 40 consists of one chrome (Cr) layer with a thickness of 5 mm. The center area of the light-reducing films 20, 40 has a wavelength characteristic of transmittance as shown in FIG. 58.

The angle characteristic (in the center area) of reflectance on the plane-substrate 11 side of the light-reducing film 20 (reflectance of internal reflection of the plane substrate 11) is shown in FIG. 59. In FIG. 59, the reflectance for the s-polarized component of the above-described light at an incidence angle of 40° or more is high. However, the reflectance for the p-polarized component of this light is low. Consequently, when the light-reducing films 20, 40 of this example are applied to an eyeglass display, the image-carrying light flux L1 desirably is limited to the s-polarized components.

The image-carrying light flux L1 is polarized because of the principle of the liquid-crystal display element 21. By optimizing the positional relation of the liquid-crystal display element 21 and the plane substrate 11 so that the polarization direction is the s-polarization direction, or by inserting a phase plate on the subsequent stage of the liquid-crystal display element 21, it is possible to limit the image-carrying light flux L1 only to the s-polarized components.

Second Modification Example of Ninth Representative Embodiment

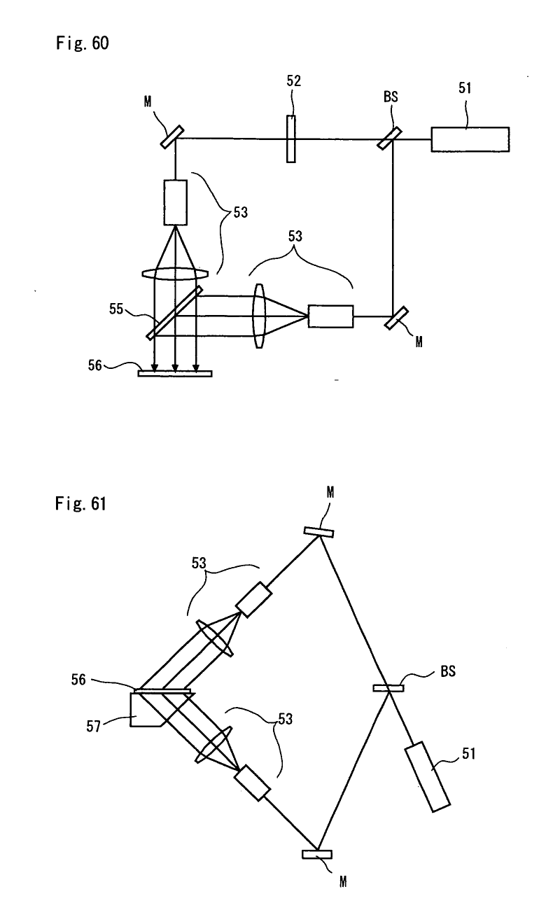

This example is shown in FIGS. 60 and 61, and is directed to the light-reducing film 20. The light-reducing film 20 of this example is made of a holographic optical film.

Exposure occurs twice during manufacture of this holographic optical film. The first exposure provides the holographic optical film with a characteristic of transmitting light at an incidence angle of approximately 0°, with specified transmittance. This exposure occurs in an optical system as shown in, for example, FIG. 60. Specifically, two light fluxes are vertically incident on a hologram photosensitive material 56. An optical attenuator is inserted in one of the light fluxes. The value of transmittance is settable by the attenuation exhibited by the optical attenuator 52. In FIG. 60, item 51 is a laser light source capable of radiating laser beams with wavelengths of R color, G color, and B color; BS denotes a beam splitter; M denotes mirrors, items 53 are beam-expanders; and item 55 is a beam-splitter.

The second exposure ensures reflectance for the image-carrying light flux L1 that is internally reflected in the plane substrate 11. This exposure occurs in an optical system as shown in, for example, FIG. 61. Specifically, two light fluxes are incident on the hologram photosensitive material 56 at the same angle as of the image-carrying light flux L1 that is internally reflected in the plane substrate 11. In FIG. 61, item 51 is a laser light source (capable of radiating laser beams with wavelengths of R color, G color, and B color); BS denotes a beam-splitter; M denotes mirrors; items 53 are beam-expanders; and item 57 is an auxiliary prism.

After the two exposures, the hologram photosensitive material 56 is developed, so that a holographic optical film is completed. The holographic optical film thus completed has the required performance of the light-reducing film 20.

Although, in this modification example, the light-reducing film 20 is made of the holographic optical film, the light-reducing film 20 and the light-reducing film 40 can comprise one holographic optical film. In manufacturing such a holographic optical film, the first exposure takes place in two divided steps. In one of the exposure steps, the center area of the holographic optical film is exposed (a peripheral area is masked). In the other exposure step, the peripheral area is exposed (the center area is masked).

In these two exposure steps, the amounts of attenuation achieved by the optical attenuator 52 are set to different values. Consequently, the transmittance of the center area and the transmittance of the peripheral area of the holographic optical film are set to different values.

### Tenth Representative Embodiment

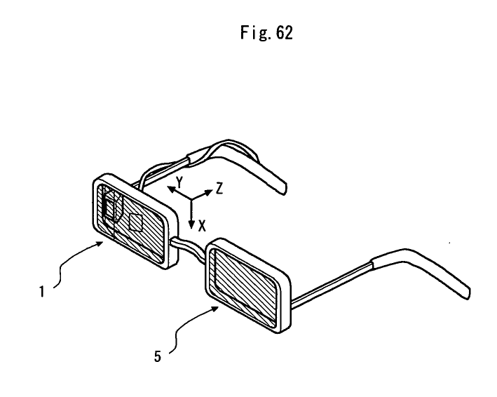

This embodiment is shown in FIGS. 62-66, and is directed to an eyeglass display. Below, only differences from the eighth representative embodiment are described.

FIG. 62 is an external view of the eyeglass display. The coordinate system in FIG. 62 is a right-handed XYZ Cartesian coordinate system in which the X-direction points downward and the Y-direction points rightward as viewed from a viewer. In the following description, the direction expressed by the XYZ coordinate system or the direction expressed by left, right, up, and down as viewed from the viewer will be used as required. In FIG. 62 the external appearance of this eyeglass display is substantially the same as of the eighth representative embodiment (see FIG. 37).

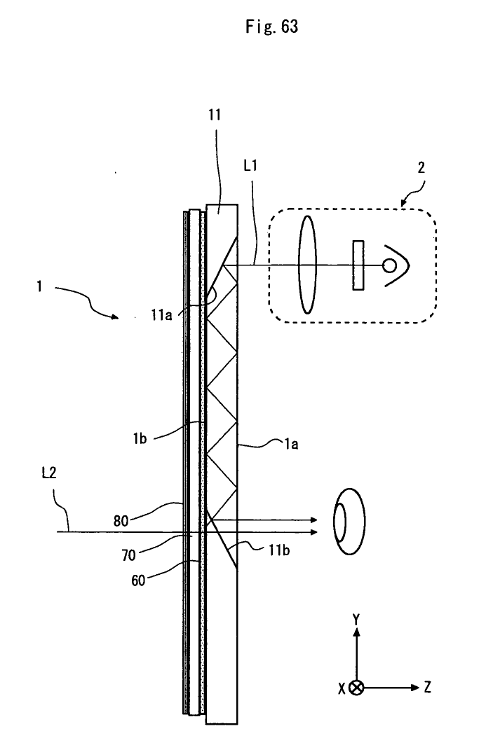

FIG. 63 is a detailed view of the optical system of this eyeglass display, and is a schematic sectional view of the optical-system portion of the eyeglass display taken along a plane parallel to a YZ plane. As shown in FIG. 63, the behavior of the image-carrying light flux L1 and of the external light flux L2 in this eyeglass display are the same as in the eighth representative embodiment (see FIG. 38). A first optical film 60 is provided on the external-side surface 1b of the plane substrate 11. A second plane substrate 70, made of optical glass, is adhered on the surface of the first optical film 60. A second optical film 80 is adhered on the surface of the second plane substrate 70. The first optical film 60 performs, with respect to the plane substrate 11, in the same manner as an air gap. Specifically, the plane-substrate 11 side interface of the first optical film 60 reflects the image-carrying light flux L1 with substantially 100% reflectance. The first optical film 60 transmits the external light flux L2. The first optical film 60 may have the function of attenuating visible light and the function of ultraviolet or infrared protection. The second plane substrate 70 and the second optical film 80 have served to attenuate the external light flux L2. The second plane substrate 70 and the second optical film 80 may have the function of attenuating visible light and the function of ultraviolet or infrared protection.

In this eyeglass display, the first optical film 60 provides reflectance for the image-carrying light flux L1 that is internally reflected in the plane substrate 11. Hence, it is not necessary for the second plane substrate 70 and the second optical film 80 to enhance the reflectance for the image-carrying light flux L1. Therefore, the degree of freedom in designing the second plane substrate 70 and the second optical film 80 is high. For example, any of various kinds of existing optical-filter glass can be used to fabricate the second plane substrate 70.

The second plane substrate 70 and the second optical film 80 can be configured to exhibit high light attenuation. This high light-attenuation means, for example, small variations in the light-attenuation ratio that depend on the incidence angle, small variations in the light-attenuation ratio depending on the wavelength, and the like.

A concrete example of the first optical film 60 is described for a case in which the image-carrying light flux L1 is limited only to s-polarized components. The structure of the first optical film 60 is as follows:

plane substrate/(0.125L 0.28H 0.15L)(0.125L 0.25H 0.125L)⁴ (0.15L 0.28H 0.125L)/second plane substrate where H is the high-refractive index dielectric (H layer), L is the low-refractive index dielectric (L layer), the numerical value on the left of each layer is the optical-layer thickness of the respective layer (in the center wavelength of the wavelength range used), and the superscript numeral is the number of stacks of the parenthesized layer group.

Details (specifications) of the first optical film 60 are as follows:
center wavelength λc: 850 nm
refractive index of the plane substrate: 1.56
refractive index of the H layers: 2.30
refractive index of the L layers: 1.48
refractive index of the second plane substrate: 1.507
extinction coefficient k of the second plane substrate=0.01

The extinction coefficient k of the second plane substrate 70 had a large value such as 0.01, with the intention of providing the second plane substrate 70 with a variety of light-attenuation characteristics and a wavelength-blocking function by using various kinds of optical-filter glass as the second plane substrate 70.

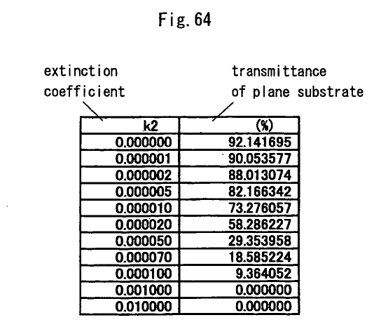

FIG. 64 shows the results of calculating the correlation between the extinction coefficient k and the transmittance of a glass substrate having a refractive index of 1.50 and thickness of 1 mm. FIG. 64 shows that the practical maximum value of the extinction coefficient k is 0.01. Hence, setting the extinction coefficient k of the second plane substrate 70 to 0.01 allows an effective configuration of the first optical film 60, no matter which optical-filter glass is used as the second plane substrate 70.

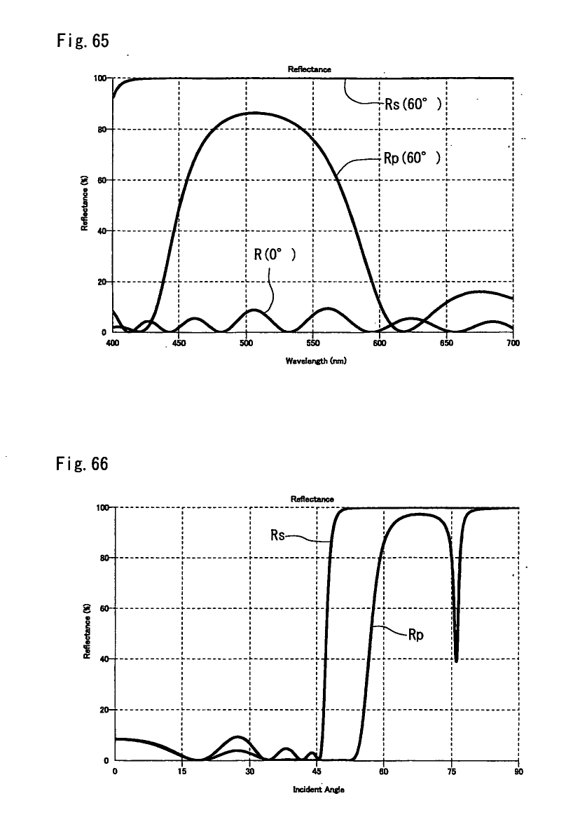

The wavelength characteristics (incidence angles of 0° and 60°) of reflectance of the plane-substrate 11 side of the first optical film 60 are shown in FIG. 65. The angle characteristics of reflectance of the second plane-substrate 70 side of the first optical film 60 are shown in FIG. 66. In FIGS. 65 and 66, the first optical film 60 exhibits a reflectance of 10% or lower on average for an s-polarized component of visible light at a 0° incidence angle. The first optical film exhibits substantially 100% reflectance for the s-polarized component of visible light at a 60° incidence angle.

As previously described, any optical-filter glass is usable as the second plane substrate 70, i.e., any of various commercially available optical-filter glasses such as an ultraviolet protector, an infrared protector, a color filter, and a neutral-density filter (a filter uniformly reducing light having all the wavelengths in the visible spectrum) can be used as the second plane substrate 70. Usable as the second optical film 80 is any film that is suitable for protecting the surface of the second plane substrate 70, e.g., an antireflection film or the like. Desirably, the second optical film 80 is selected for its ability, when combined with the second plane substrate, achieves a desired performance. For example, a neutral-density filter may be used as the second plane substrate 70, and an infrared protection film may be used as the second optical film 80. An ultraviolet protection glass may be used as the second plane substrate 70, and a light-reducing film and an ultraviolet protection film may be used as the second optical film 80. In short, the combination of the second plane substrate 70 and the second optical film 80 is appropriately selectable according to factors such as the desired performance of the eyeglass display, the manufacturing cost of the eyeglass display, and the like.

The types and functions of various multilayer films such as various types of filters are described in detail in references such as MacLeod, Thin-Film Optical Filters, 3^{rd} Edition, Taylor and Francis, 2001 thereof. The reason for the one-cycle layer groups being disposed on both sides of the plural-cycle layer groups in the above-described structure of the first optical film 60 is to adjust mismatch in refractive index between the first optical film 60 and the plane substrate 11 and to adjust mismatch in refractive index between the first optical film 60 and the second plane substrate 70 (i.e., each of the one-cycle layer groups is a matching layer). The matching layer finely adjusts the characteristic of the first optical film 60, such as reducing ripples in the wavelength band for which transmittance should be reduced.

### Modification Example of Tenth Embodiment

The first optical film 60 may have a different structure from the structure described in the tenth representative embodiment. Whichever structure is applied, appropriate cycle layer groups are included. Further, whichever structure is applied, it desirably is optimized by computer.

As the combination of the second optical film 80 and the second plane substrate 70, the combination of a metal film of chrome (Cr) or the like and an optical glass substrate having a small extinction coefficient k can be used. As the second optical film 80, any of various types of functional thin films can be used, for example, an electrochromic film (EC film), a photochromic film (PC film), or the like. Use of an electrochromic film (EC film) enables a user to select the degree of necessity of light reduction according to the usage state of the eyeglass display by a user's turning-on operation. For example, a user can make the following selection, for instance: to reduce light whenever the external image is extremely bright in the event the eyeglass display is being used outdoors in the daytime; and not to reduce light whenever the external image is not very bright in the event the eyeglass display is being used indoors. Thus, both visibility of the external image and visibility of a display image can be maintained irrespective of the usage state of the eyeglass display. If a photochromic thin film (PC film) is used, the external light flux L2 is automatically reduced only when light intensity of the external light flux L2 is high, so that visibility of an external image and visibility of a display image are both automatically maintained irrespective of the usage state of the eyeglass display. Applying these functional thin films dramatically improves performance of the eyeglass display.

As in the ninth representative embodiment, the light-attenuation ratio of the center area of the image-display optical system 1 can be easily set higher than the light-attenuation ratio of the peripheral area of the image-display optical system 1. For example, the second plane substrate 70 can be made of a neutral density filter, the second optical film 80 can be made of a light-reducing film, and the formation area of the second optical film 80 can be limited only to the center area.

In this eyeglass display, the first optical film 60 can be made of a holographic optical film. The optical system shown in FIG. 61 is usable in manufacturing this holographic optical film. Since the first optical film 60 during use is sandwiched between the plane substrate 11 and the second plane substrate 70, auxiliary prisms in the same shape as of these plane substrates are disposed in the optical paths of the two light fluxes in FIG. 61. In this eyeglass display the second optical film 80 can be made of a holographic optical film.

### Other Exemplary Embodiment

The light-reducing function of any of the eighth, ninth, and tenth representative embodiments (including the modification examples) described above may be provided in the eyeglass display of any of the first through seventh representative embodiment embodiments.

### INDUSTRIAL APPLICABILITY

In the above-described embodiments, only the eyeglass display is described, but the invention is similarly applicable to a finder and the like of a camera, to binoculars, to a microscope, to a telescope, or the like.

The invention is not limited to the above embodiments and various modifications may be made without departing from the spirit and scope of the invention. Any improvement may be made in part or all of the components.

1. An optical element, comprising:
a plane substrate having a surface and an interior through which a specified light flux can propagate; and
an optical-function unit situated in close contact with the surface of the plane substrate, the optical-function unit being reachable by the propagating specified light flux, the optical-function unit being configured to have interfering or diffracting actions that reflects the specified light flux and transmits an external light flux reaching the surface.

2. The optical element according to claim 1, wherein the optical-function unit is configured to reflect the specified light flux that is polarized in a specific direction, and to transmit a light flux polarized in another direction.

3. The optical element according to claim 1, wherein:
the optical-function unit is configured to reflect, with a desired reflection characteristic, the specified light flux reaching the surface at an incidence angle equal to or larger than a critical angle, the critical angle being determined by respective refractive indices of the plane substrate and air and being a condition under which a light flux in the interior of the plane substrate is reflected totally.

4. The optical element according to claim 1, wherein the optical-function unit is configured to reduce the external light flux without increasing a loss of light intensity of a light path of the specified light flux.

5. A combiner optical system, comprising:
an optical element as recited in claim 1, in which an image-carrying light flux radiated from a specified image-display element propagates, the optical element transmits the external light flux directed from an external field to a viewing eye at least in a state in which the plane substrate faces the viewing eye; and
a combiner provided in the optical element, the combiner being configured to reflect the image-carrying light flux, that has propagated in the plane substrate, toward the viewing eye and to transmit the external light flux.

6. The combiner optical system of claim 5, wherein:
the optical-function unit is an optical film provided on the surface of the plane substrate; and
a second plane substrate is provided on a surface of the optical film.

7. The combiner optical system of claim 6, wherein the second plane substrate is a refractor configured to perform diopter correction.

8. The combiner optical system of claim 6, wherein:
the optical-function unit is provided on an external-side surface of the plane substrate; and
the combiner optical system further comprises an optical system that includes the optical-function unit and the second plane substrate, the optical system being configured to reduce the external light flux without increasing attenuation of light intensity of an optical path of the image-carrying light flux.

9. The combiner optical system of claim 8, wherein the second plane substrate is configured to absorb visible light.

10. The combiner optical system of claim 8, wherein the optical film is configured to reduce the external light flux without increasing attenuation of light intensity of an optical path of the image-carrying light flux.

11. The combiner optical system of claim 8, wherein the optical film is made of metal and/or a dielectric.

12. The combiner optical system of claim 8, wherein the optical film is made of a holographic optical film.

13. The combiner optical system of claim 8, further comprising a second optical film on a surface of the second plane substrate.

14. The combiner optical system of claim 13, wherein the second optical film is made of metal and/or a dielectric.

15. The combiner optical system of claim 13, wherein the second optical film is made of a holographic optical film.

16. The combiner optical system of claim 13, wherein the second optical film is made of an electrochromic film.

17. The combiner optical system of claim 13, wherein the second optical film is made of a photochromic film.

18. The combiner optical system of claim 8, further comprising an optical system including the optical-function unit and the second plane substrate, the optical system being configured to reduce the external light flux that is incident on the combiner, at a higher reduction ratio than a reduction ratio at which a rest of the external light flux is reduced.

19. The combiner optical system of claim 5, further comprising a guide mirror configured to guide the image-carrying light flux, radiated from the image-display element, in a direction allowing the image-carrying light flux to be internally reflected in the plane substrate.

20. An image-display unit, comprising:
an image-display element configured to radiate an image-carrying light flux for image display; and
the combiner optical system, as recited in claim 5, configured to guide the image-carrying light flux to the viewing eye.

21. The image-display unit of claim 20, further comprising a mounting member with which the combiner optical system is worn on a head of a viewer.

22. The combiner optical system of claim 8, further comprising a guide mirror configured to guide the image-carrying light flux, radiated from the image-display element, in a direction allowing the image-carrying light flux to be internally reflected in the plane substrate.

23. An image-display unit, comprising:
an image-display element configured to radiate an image-carrying light flux for image display; and
the combiner optical system, as recited in claim 8, configured to guide the image-carrying light flux to the viewing eye.
